(19) United States
(12) Patent Application Publication
(10) Pub. No.: US 2024/0227357 A1
(43) Pub. Date: Jul. 11, 2024

(54) Fluoropolymer Compositions and Methods Suitable for Copper Substrates and Electronic Telecommunications Articles

(71) Applicant: 3M INNOVATIVE PROPERTIES COMPANY, St. Paul, MN (US)

(72) Inventors: Naiyong Jing, St. Paul, MN (US); Xiaoming Kou, Woodbury, MN (US); Leon M. Lillie, St. Paul, MN (US); Maria C. Lindsay, Minneapolis, MN (US); Tatsuo Fukushi, Woodbury, MN (US); Steffen Vowinkel, Muhldorf am Inn (DE); Jun Chen, Shanghai (CN); Hong Qian, Shanghai (CN); Zai-Ming Qiu, Woodbury, MN (US); Timothy A. Mertens, West Lakeland, MN (US)

(21) Appl. No.: 18/303,674

(22) Filed: Apr. 20, 2023

Related U.S. Application Data
(60) Provisional application No. 63/341,037, filed on May 12, 2022.

(51) Int. Cl. B32B 15/08; B32B 15/20; B32B 37/06

(52) U.S. Cl. CPC B32B 15/08; B32B 15/20; B32B 37/06; B32B 2307/41; B32B 2309/025; B32B 2310/0831; B32B 2327/18; B32B 2457/08

(57) ABSTRACT

A method of bonding a substrate is described comprising providing a fluoropolymer film comprising: i) a first fluoropolymer comprising at least 80, 85, or 90 wt. % of polymerized perfluorinated monomers; ii) optionally a second fluoropolymer having a greater amount of polymerized tetrafluoroethylene than the first fluoropolymer; wherein the first fluoropolymer and/or second fluoropolymer when present comprises halogen cure sites; and iii) one or more compounds comprising an electron donor group and one or more ethylenically unsaturated groups; applying the fluoropolymer film to a substrate; and heating the fluoropolymer film to a temperature of at least 150, 160, 170, 180, 190 or 200° C.

### SUMMARY

Although various methods of bonding substrates with fluoropolymer compositions have been described, industry would find advantage in methods of bonding that provide high adhesion at elevated temperatures.

In one embodiment, a method of bonding a substrate is described comprising: providing a fluoropolymer film comprising:
i) a first fluoropolymer comprising at least 80, 85, or 90 wt. % of polymerized perfluorinated monomers;
ii) optionally a second fluoropolymer having a greater amount of polymerized tetrafluoroethylene than the first fluoropolymer;
wherein the first fluoropolymer and/or second fluoropolymer when present comprises halogen cure sites;
iii) one or more compounds comprising an electron donor group and one or more ethylenically unsaturated groups;
   applying the fluoropolymer film to a substrate; and
   heating the fluoropolymer film to a temperature of at least 150, 160, 170, 180, 190 or 200° C.

The method lacks exposing the fluoropolymer film to ultraviolet radiation. The method is particularly useful for opaque substrates having little or no transmission of ultraviolet radiation. In some embodiments, the substrate is metal or copper. The fluoropolymer film can have low dielectric constant (Dk) and low dielectric loss (Df) values. In some embodiments, the substrate is a component of a telecommunications article, such as a printed circuit boards.

In some embodiments, the fluoropolymer film is obtained by providing a coating solution of i), ii) and iii) and a fluorinated solvent, applying the coating solution to the substrate or a release liner, and removing the solvent. In other embodiments, the fluoropolymer film is obtained by melt extruding the fluoropolymer film.

In some embodiments, wherein ii) is present, the method further comprises heating the fluoropolymer film to a temperature at or above the melting temperature of the second fluoropolymer when the second fluoropolymer has a melting temperature greater than bonding temperature.

In some embodiments, the fluoropolymer film comprises particles of the second fluoropolymer. The particles of the second fluoropolymer have a particle size up to 1 micron, a particles size greater than 1 micron, or a combination thereof. The amount of second fluoropolymer is typically at least 30, 35, 40, 45, or 50 wt. % based on the total weight of the fluoropolymers.

In another embodiment, an article is described comprising a substrate and the described fluoropolymer film (e.g. layer) disposed on the substrate. The fluoropolymer layer has a bond strength to the substrate at 120° C. or 150° C. of at least 1 N/cm. In some embodiments. such bond strength is obtained after heating to 200° C. for 60 minutes. In other embodiments, the heating step also comprises heating at 288° C. for 15-20 minutes. In some embodiments, the substrate is copper.

Also described are fluoropolymer compositions comprising i), ii), and iii) as previously described. In some embodiments, iii) are compound(s) that lack an amine group.

### BRIEF DESCRIPTION OF THE DRAWINGS

FIG. 1 is a illustrative cross section of an illustrative printed circuit board (PCB) substrate;

FIG. 2 is a perspective view of an illustrative printed circuit board (PCB) including integrated circuits;

FIGS. 3A and 3B are cross-sectional diagrams of illustrative fluoropolymer passivation and insulating layers.

### DETAILED DESCRIPTION

Presently described are certain fluoropolymer films and compositions suitable for bonding to substrates such a metal (e.g. copper). In one embodiments, the fluoropolymer compositions are suitable for use in electronic telecommunication articles, such as described in WO2021/091864. As used herein, electronic refers to devices using the electromagnetic spectrum (e.g. electons, photons); whereas telecommunication is the transmission of signs, signals, messages, words, writings, images and sounds or information of any nature by wire, radio, optical or other electromagnetic systems.

The fluoropolymer film or layer is typically an insulating layer, passivation layer, cladding, protective layer, or a combination thereof of an electronic telecommunication articles such as an integrated circuit, printed circuit board, antenna, or optical cable.

Perfluoropolymers can have substantially lower dielectric constants and dielectric loss properties than polyimides which is particularly important for fifth generation cellular network technology (“5G”) articles. For example, fluoropolymer films and compositions described herein can have a dielectric constant (Dk) of less than 2.75, 2.70, 2.65, 2.60, 2.55, 2.50, 2.45, 2.40, 2.35, 2.30, 2.25, 2.20, 2.15, 2.10, 2.05, 2.00, or 1.95. In some embodiments, the dielectric constant is at least 2.02, 2.03, 2.04, 2.05. Further. fluoropolymer films and compositions described herein can have a low dielectric loss, typically less than 0.01, 0.009, 0.008, 0.007, 0.006, 0.005, 0.004, 0.003, 0.002, 0.001, 0.0009, 0.0008, 0.0007, 0.0006, 0.0005, 0.0004, 0.0003 at low and high frequencies, including 25 GHz. In some embodiments, the dielectric loss is at least 0.00022, 0.00023, 0.00024, 0.00025. The dielectric properties (e.g. constant and loss) can be determined according to the test method described in the examples. As the number of non-fluorine atoms increases (e.g. number of carbon-hydrogen and/or carbon-oxygen bonds increases) the dielectric constant and dielectric loss also typically increases.

The fluoropolymer film and composition are particularly useful for bonding to metals, such as copper. Thus, the fluoropolymer film and composition are particularly suitable for use for copper clade laminates and printed circuit boards (PCBs).

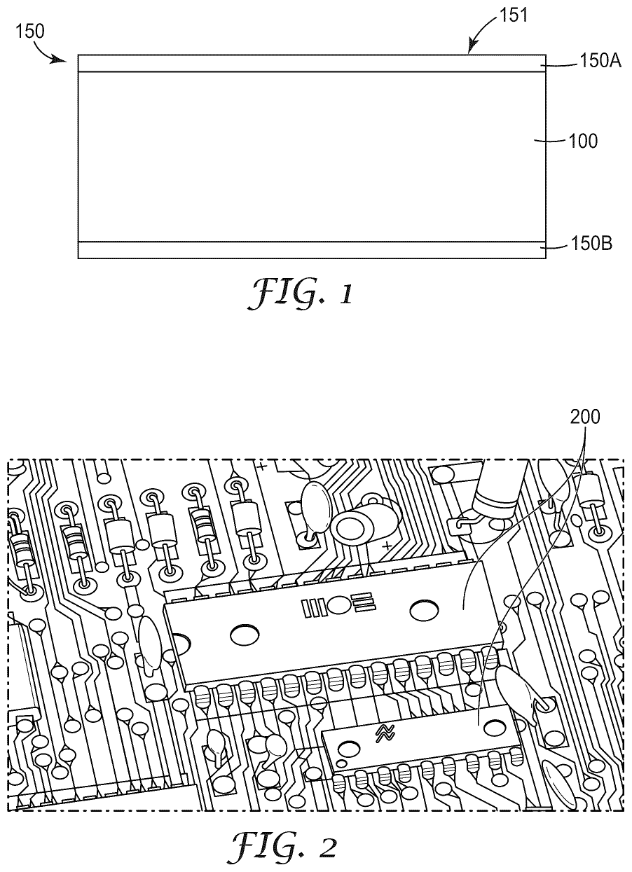

With reference to FIG. 1, an illustrative PCB includes a layer of fiberglass 100 bonded with an epoxy resin between two layers of copper foil, 150A and 150B. The fluoropolymer composition (e.g. coating or melt extruded film) described herein can be used in place of the epoxy resin or in place of the entire fiberglass/epoxy substrate.

In another embodiment, a fluoropolymer (e.g. photoresist) layer can be disposed upon major surface 151 of the metal (e.g. copper) substrate in the manufacture of a printed circuit board (PCB) such as described in WO2021/091864. An illustrative perspective view of a printed circuit board (PCB) is depicted in FIG. 2. A printed circuit board, or PCB, is used to mechanically support and electrically connect electronic components using conductive pathways, tracks or signal traces etched from (e.g. copper) metal sheets laminated onto a non-conductive substrate. Such boards are typically made from an insulating material such as glass fiber reinforced (fiberglass) epoxy resin or paper reinforced phenolic resin. The pathways for electricity are typically made from a negative photoresist, as previously described. Thus, in this embodiment, the crosslinked fluoropolymer is disposed on the surface of the (e.g. copper) metal substrate. Portions of uncrosslinked fluoropolymer are removed to form the conductive (e.g. copper) pathways. Crosslinked fluoropolymer (e.g. photoresist) remain present, disposed between the conductive (e.g. copper) pathways of the printed circuit board. Solder is used to mount components on the surface of these boards. In some embodiments, the printed circuit board further comprises integrated circuits 200, as depicted in FIG. 2. Printed circuit board assemblies have an application in almost every electronic article including computers, computer printers, televisions, and cell phones.

In another embodiment, the fluoropolymer film described herein can be utilized as an insulating layer, passivation layer, and/or protective layer in the manufacture of integrated circuits.

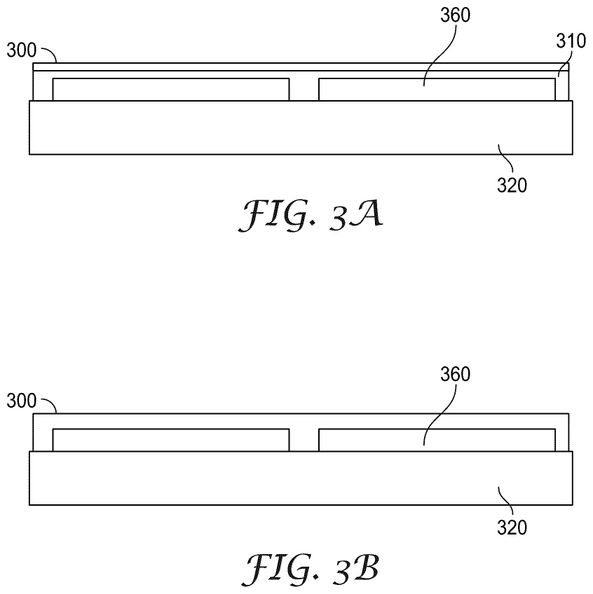

With reference to FIG. 3A, in one embodiment, a thin fluoropolymer film 300 (e.g. typically having a thickness less than 50, 40, or 30 nm) can be disposed on a passivation layer 310 (e.g. SiO₂) disposed on an electrode patterned 360 silicon chip 320.

With reference to FIG. 3B, in another embodiment, a thicker fluoropolymer film 300 (e.g. typically having a thickness of at least 100, 200, 300, 400, 500 nm) can be disposed on an electrode patterned 360 silicon chip 320. In this embodiment, the fluoropolymer layer may function as both a passivation layer and an insulating layer. Passivation is the use of a thin coating to provide electrical stability by isolating the transistor surface from electrical and chemical conditions of the environment.

In another embodiment, the fluoropolymer film described herein can be utilized as a substrate for antennas. The antenna of the transmitter emits (e.g. high frequency) energy into space while the antenna of the receiver catches this and converts it into electricity.

The low dielectric fluoropolymer films and coatings described herein can also be utilized as insulating and protective layers of transmitter antennas of cell towers and other (e.g. outdoor) structures.

In another embodiment, the low dielectric fluoropolymer compositions described herein may also be utilized in fiber optic cable. The low dielectric fluoropolymer compositions described herein can be used as the cladding, coating, outer jacket, or combination thereof.

In other embodiments, the low dielectric fluoropolymer films and coatings described herein can also be utilized for flexible cables and as an insulating film on magnet wire. For example, in a laptop computer, the cable that connects the main logic board to the display (which must flex every time the laptop is opened or closed) may be a low dielectric fluoropolymer composition as described herein with copper conductors.

The electronic telecommunication article may or may not be a sealing component of equipment used in wafer and chip production.

One of ordinary skill in the art appreciates that the low dielectric fluoropolymer compositions described herein can be utilized in various electronic telecommunication articles, particularly in place of polyimide, and such utility is not limited to the specific articles described herein.

### First Fluoropolymer

The fluoropolymer film and composition comprises a first fluoropolymer that comprises predominantly, or exclusively, (e.g. repeating) polymerized units derived from two or more perfluorinated comonomers. “Predominantly” as used herein means at least 80, 85, or 90% by weight based on the total weight of the fluoropolymer, of the polymerized units of the fluoropolymer are derived from such perfluorinated comonomers such as tetrafluoroethene (TFE) and one or more unsaturated perfluorinated alkyl ethers. In some embodiments, the fluoropolymer comprises at least 81, 82, 83, 84, 85, 86, 87, 88, 90, 91, 92, 93, 94, 95, 96, or 97% by weight or greater of such perfluorinated comonomers, based on the total weight of the fluoropolymer. High concentrations of polymerized perfluorinated monomer(s) is typically preferred for reducing the dielectric properties (e.g. Dk and Df).

In some embodiment, first fluoropolymer comprises at least 40, 45, or 50% by weight of polymerized units derived from TFE. In some embodiments, the maximum amount of polymerized units derived from TFE is no greater than 60% or 55% by weight.

In some embodiments, the one or more unsaturated perfluorinated alkyl ethers are selected from the general formula:

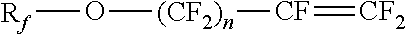

wherein n is 1 (allyl ether) or 0 (vinyl ether) and R_{f} represents a perfluoroalkyl residue which may be interrupted once or more than once by an oxygen atom. R_{f} may contain up to 10 carbon atoms, e.g. 1, 2, 3, 4, 5, 6, 7, 8, 9 or 10 carbon atoms. Preferably R_{f} contains up to 8, more preferably up to 6 carbon atoms and most preferably 3 or 4 carbon atoms. In one embodiment R_{f} has 3 carbon atoms. In another embodiment R_{f} has 1 carbon atom. R_{f} may be linear or branched, and it may contain or not contain a cyclic unit. Specific examples of R_{f} include residues with one or more ether functions including but not limited to:

—(CF₂)—O—C₃F₇,

—(CF₂)₂—O—C₂F₅,

—(CF₂)ᵣ₃—O—CF₃,

—(CF₂—O)—C₃F₇,

—(CF₂—O)₂—C₂F₅,

—(CF₂—O)₃—CF₃,

—(CF₂CF₂—O)—C₃F₇,

—(CF₂CF₂—O)₂—C₂F₅,

—(CF₂CF₂—O)₃—CF₃,

Other specific examples for R_{f} include residues that do not contain an ether function and include but are not limited to —C₄F₉; —C₃F₇, —C₂F₅, —CF₃, wherein the C₄ and C₃ residues may be branched or linear, but preferably are linear.

The unsaturated perfluorinated alkyl either may comprise allyl or vinyl groups. Whereas a perfluorinated vinyl group is CF₂═CF— and a perfluorinated allyl group is CF₂═CFCF₂—, both have C—C double bonds.

Specific examples of suitable perfluorinated alkyl vinyl ethers (PAVE's) and perfluorinated alkyl allyl ethers (PAAE's) include but are not limited to perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, CF₂═CF—O—CF₂—O—C₂F₅, CF₂═CF—O—CF₂—O—C₃F₇, CF₃—(CF₂)₂—O—CF(CF₃)—CF₂—O—CF(CF₃)—CF₂—O—CF═CF₂ and their allyl ether homologues. Specific examples of allyl ethers include CF₂—CF—CF₂—O—CF₃, CF₂═CF—CF₂—O—C₃F₇, CF₂═CF—CF₂—O—(CF₃)₃—O—CF₃. Further examples include but are not limited to the vinyl ether described in European patent application EP 1,997,795 B1.

In some embodiments, the fluoropolymer comprises polymerized units of at least one allyl ether, such as alkyl vinyl ether is CF_{2═}CFCF₂OCF₂CF₂CF₃. Such fluoropolymers are described in WO 2019/161153, incorporated herein by reference.

Perfluorinated ethers as described above are commercially available, for example from Anles Ltd., St. Petersburg, Russia and other companies or may be prepared according to methods described in U.S. Pat. No. 4,349,650 (Krespan) or European Patent 1,997,795, or by modifications thereof as known to a skilled person.

In some embodiments, the one or more unsaturated perfluorinated alkyl ethers comprises unsaturated cyclic perfluorinated alkyl ethers, such as 2,2-bistrifluoromethyl-4,5-difluoro-1,3 dioxole. Fluoropolymers that comprise predominantly, or exclusively comprise, (e.g. repeating) polymerized units derived from tetrafluoroethene (TFE) and such unsaturated cyclic perfluorinated alkyl ethers are commercially available as “TEFLON™ AF”, “CYTOP™” and “HYFLON™”. For amorphous polymers containing cyclic perfluorinated alky ether units. the glass transition temperature is typically at least 70° C., 80° C., or 90° C., and may range up to 220° C., 250° C., 270° C., or 290° C. The MFI (297° C./5 kg) is between 0.1-1000 g/10 min.

In other embodiments, the first fluoropolymer is substantially free of unsaturated cyclic perfluorinated alkyl ethers, such as 2,2-bistrifluoromethyl-4,5-difluoro-1,3 dioxole. By substantially free it is meant that the amount is zero or sufficiently low such the fluoropolymer properties are the same (i.e. within normal variation of a physical property).

In some embodiments, the first fluoropolymer comprises polymerized units derived from one or more of the unsaturated perfluorinated alkyl ethers (PAVE) (e.g. PMVE, PAAE or a combination thereof), in an amount of at least 10, 15, 20, 25, 30, 45, or 50% by weight, based on the total polymerized monomer units of the fluoropolymer. In some embodiments, the fluoropolymer comprises no greater than 50, 45, 40, or 35% by weight of polymerized units derived from one or more of the unsaturated perfluorinated alkyl ethers (PMVE, PAAE or a combination thereof), based on the total polymerized monomer units of the fluoropolymer. The molar ratio of units derived from TFE to the perfluorinated alkyl ethers described above may be, for example, from 1:1 to 5:1. In some embodiments, the molar ratio ranges from 1.5:1 to 3:1.

First fluoropolymers comprising a sufficient amount of polymerized units of one or more of the unsaturated perfluorinated alkyl ethers, as described herein, are typically amorphous fluoropolymers. In typical embodiments, the amorphous fluoropolymers contain essentially no crystallinity or possess no significant melting temperature (peak maximum) as determined by differential scanning calorimetry in accordance with DIN EN ISO 11357-3:2013-04 under nitrogen flow and a heating rate of 10° C./min. Alternatively, the amorphous fluoropolymer may be semi-crystalline provided the amorphous lfuoropolmyer is soluble in fluorinated solvent such as 3-ethoxy perfluorinated 2-methyl hexane and 3-methoxy perfluorinated 4-methyl pentane.

Typical amorphous first fluoropolymers have a glass transition temperature (Tg) of less than 26° C., less than 20° C., or less than 0° C., and for example from −40° C. to 20° C., or −50° C. to 15° C., or −55° C. to 10° C. The amorphous fluoropolymers typically have a Mooney viscosity (ML 1+10 at 121° C.) of at least 2, 10, 20, 30, or 40. The amorphous fluoropolymers typically have a Mooney viscosity (ML 1+10 at 121° C.) no greater than 200 or 100. In some favored embodiment, the Mooney viscosity is no greater than 90, 85, 80, or 75. The favored Mooney viscosity can be obtained with a single amorphous fluoropolymer typically having a normal molecular weight distribution. Alternatively, the Mooney viscosity can be obtained with a blend of two of more amorphous fluoropolymers. For example, a first amorphous fluoropolymer, having a higher Mooney viscosity of (e.g. 90), can be blended with a second amorphous fluoropolymer having a lower Mooney viscosity of (e.g. 40). As yet another example, a first amorphous fluoropolymer, having a higher Mooney viscosity of about 50, can be blended with a second amorphous fluoropolymer having a lower Mooney viscosity of (e.g. 40).

The fluorine content of the fluoropolymer is typically at least 60, 65, 66, 67, 68, 69, or 70 wt. % of the fluoropolymer and typically no greater than 76, 75, 74, 73, 72, 71 or 70 wt. %. The fluorine content may be achieved by selecting the comonomers and their amounts accordingly.

Such highly-fluorinated amorphous fluoropolymers typically do not dissolve non-fluorinated solvent organic liquid (e.g. methyl ethyl ketone (“MEK”), tetrahydrofuran (“THF”), ethyl acetate or N-methyl pyrrolidinone (“NMP”) at a concentration of 1 wt. % amorphous first fluoropolymer.

The amorphous fluoropolymer may be described as a gum or particles derived from a coagulated and dried latex.

### Crystalline Fluoropolymer

The fluoropolymer film and composition optionally comprises a second fluoropolymer having a greater amount of polymerized tetrafluoroethylene than the first fluoropolymer. The second fluoropolymer comprises at least 40, 45, 50, 55, 60, 65, and more typically 70, 75, 80, 85, 90, 95 or about 100 wt. % of polymerized units of TFE.

Due to the higher concentration of TFE, the second fluoropolymer is typically a crystalline fluoropolymer having a significant melting temperature (peak maximum) as determined by differential scanning calorimetry in accordance with DIN EN ISO 11357-3:2013-04 under nitrogen flow and a heating rate of 10° C./min. Thus, the second crystalline fluoropolymer is typically thermoplastic and may be characterized as a fluoroplastic. The second crystalline fluoropolymer typically has a melt temperature of at least 100, 110, 120, or 130° C. and no greater than 350, 340, 330, 320, 310 or 300° C.

Crystallinity depends on the selection and concentration of polymerized monomers of the fluoropolymer. For example, PTFE homopolymers (containing 100% TFE-units) have a melting temperature (Tm) above 340° C. The addition of comonomers, such as the unsaturated (per)fluorinated alkyl ethers, reduces the Tm. For example, when the fluoropolymer contains about 3-5 wt. % of polymerized units of such comonomer, the Tm is about 310° C. As yet another example, when the fluoropolymer contains about 15-20 wt. % of polymerized units of HFP, the Tm is about 260-270° C. As yet another example, when the fluoropolymer contains 30 wt. % of polymerized units of (per)fluorinated alkyl ethers (e.g. PMVE) or other comonomer(s) that reduce the crystallinity the fluoropolymer no longer has a detectable melting temperature via DSC, and thus is characterized as being amorphous. Thus, the second fluoropolymer comprises a lower concentration of unsaturated (per)fluorinated alkyl ethers than the first flurorpolymer. In typical embodiments, the second fluoropolymer comprises less than 30, 25, 20, 15, 10, 5, or 1 wt. % of polymerized units of (per)fluorinated alkyl ethers.

Some specifc crystalline fluoropolymers that can be derived from aqueous dispersions, as described in PCT/IB2022/053284, include: fluoropolymers comprising 87 wt. % TFE and 13 wt. % HFP, (MFI (372° C./5 kg)=3 or 7 grams/10 minutes; and Tm of 260° C.); fluoropolymers comprising 96 wt. % TFE, 4 wt. % PPVE, (Tm of 308° C., MFI (372° C./5 kg)=7 g/10 minutes); fluoropolymers comprising 96 wt. % TFE, 4 wt. % PPVE (Tm of 306° C. (MFI 372° C./5 kg=2 grams/10 minutes); fluoropolymers comprising 87 wt. % TFE and 13 wt. % HFP (Tm of 255° C.); and fluoropolymers comprising 74 wt. % TFE, 20 wt. % ethylene, 2 wt. % HFP and 4 wt. % PPVE (Tm of 266° C., MFI (372° C./5 kg)=10 grams/10 minutes).

In some embodiments, the second fluoropolymer comprises polymerized units of VDF and HFP. For example, a fluoropolymer comprising about 45 wt. % of polymerized units of TFE, about 18 wt. % of polymerized units of HFP, and about 37 wt. % of polymerized units of VDF has a Tm of about 120° C. As yet another example, a fluoropolymer comprising about 76 wt. % of polymerized units of TFE, about 11 wt. % of polymerized units of HFP, and about 13 wt. % of polymerized units of VDF has a Tm of about 240° C. By increasing the polymerized units of HFP/VDF, while reducing the polymerized units of TFE, the fluoropolymer becomes amorphous. An overview of crystalline and amorphous Fluoropolymers is described by Ullmann's Encyclopedia of Industrial Chemistry (7^{th} Edition, 2013 Wiley-VCH Verlag. 10. 1002/14356007.a11 393 pub 2) Chapter: Fluoropolymers, Organic.

In some embodiments, the fluoropolymers of the compositions described here comprise little or no polymerized units of vinylidene fluoride (VDF) (i.e. CH₂═CF₂) or VDF coupled to hexafluoropropylene (HFP). Polymerized units of VDF can undergo dehydrofluorination (i.e. an HF elimination reaction) as described in US2006/0147723.

In some embodiments, the second crystalline fluoropolymers comprise little or no polymerized units of VDF. The amount of polymerized units of VDF is typically no greater than 5, 4, 3, 2, or 1 wt. % of the total second fluoropolymer.

In some embodiments, the second crystalline fluoropolymers comprise polymerized units of HFP. The amount of polymerized units of HFP can be at least 1, 2, 3, 4, 5 wt. % of the total crystalline fluoropolymer. In some embodiments, the amount of polymerized units of HFP is no greater than 15, 14, 13, 12, 11, or 10 wt. % of the total crystalline fluoropolymer.

The second crystalline fluoropolymer typically has a fluorine content of at least 50, 55, 60 or 65 wt. %. The second crystalline fluoropolymer typically has a fluorine content of no greater than 76% (in the case of PTFE homopolymer), but can be lower when the PTFE further comprises small amounts of comonomer.

Representative crystalline fluoropolymers include, for example, perfluorinated fluoropolymers such as 3M™ Dyneon™ PTFE Dispersions TF 5032Z, TF 5033Z, TF 5035Z, TF 5050Z, TF 5135GZ, and TF 5070GZ; and 3M™ Dyneon™ Fluorothermoplastic Dispersions PFA 6900GZ, PFA 6910GZ, FEP 6300GZ, THV 221, THV 340Z, and THV 800. Other suitable fluoropolymer (e.g. particles) are available from suppliers such as Asahi Glass, Solvay Solexis, and Daikin Industries and will be familiar to those skilled in the art.

The fluoropolymer film or (e.g. coating) composition) may comprise crystalline fluoropolymer particles.

In some embodiments, the fluoropolymer particles may be characterized as an “agglomerate” (e.g. of latex particles), meaning a weak association between primary particles such as particles held together by charge or polarity. Agglomerates are typically physically broken down into smaller entities such as primary particles during preparation of the coating solution. In other embodiments, the fluoropolymer particles may be characterized as an “aggregate”, meaning strongly bonded or fused particles, such as covalently bonded particles or thermally bonded particles prepared by processes such as sintering, electric arc, flame hydrolysis, or plasma. Aggregates are typically not broken down into smaller entities such as primary particles during preparation of the coating solution. “Primary particle size” refers to the mean diameter of a single (non-aggregate, non-agglomerate) particle.

The crystalline fluoropolymers particles may be derived from a coagulated latex, as will subsequently be described. Fluoropolymer particles derived from a coagulated latex have an average (e.g. primary) particle diameter of no greater than 1 micron and typically less than 500, 400, 300, or 200 nm. The fluoropolymer particles typically have an average (e.g. primary) particle diameter of at least 50 nm. Coagulated fluoropolymer particles can comprise a particle size less than 1 micron or aggregates or agglomerates of such primary particles.

In some embodiments, fluoropolymer film and composition comprises fluoropolymer particles have a particle size of greater than 1 micron. In typical embodiments, the fluoropolymer particles have an average particle size of no greater than 75, 70, 65, 60, 55, 50, 45, 35, 30, 30, 25, 20, 15, 10, or 5 microns. In some embodiments, the particle size of the fluoropolymer particles is less than the thickness of the fluoropolymer coating or fluoropolymer film layer. The average particle size is typically reported by the supplier. The particle size of the fluoropolymer particles of the fluoropolymer film can be determined by microscopy.

In some embodiments, the fluoropolymer particles comprise a mixture of particles including fluoropolymer particles having a particle size of greater than 1 micron and fluoropolymer particles having a particle size of 1 micron or less. The weight ratio of fluoropolymer particles having a particle size greater than 1 micron to fluoropolymer particles having a particle size of 1 micron or less typically ranges from 1:1 to 10:1. In some embodiments, the weight ratio of larger to smaller fluoropolymer particles is at least 2:1, 3:1, 4:1, 5:1, 6:1, 7:1, 8:1 or 9:1.

The first (e.g. amorphous) fluoropolymer (e.g. particles) and second crystalline fluoropolymer (e.g. particles) may be combined at a variety of ratios. In some embodiments. the fluoropolymer film or composition contains at least 40, 45, 50, 55, 60, 65, or 70 wt. % of first (e.g. amorphous) fluoropolymer based on the total wight of the fluoropolymers. In some embodiments, the fluoropolymer film or composition contains at least 5, 10, 15, 20, 25, 30, 35, 40, 45, or 50 wt. % of second crystalline fluoropolymer based on the total wight of the fluoropolymers.

The crystalline fluoropolymer (e.g. particles) are insoluble in fluorinated solvent. The crystalline fluoropolymer (e.g. particles) are also insoluble in non-fluorinated organic solvent such as methyl ethyl ketone (“MEK”), tetrahydrofuran (“THF”), ethyl acetate or N-methyl pyrrolidinone (“NMP”). By insoluble it is meant that less than 1, 0.5, 0.1, 0.01, 0.001 wt. % of the fluoropolymer is soluble in fluorinated solvent such as 3-ethoxy perfluorinated 2-methyl hexane and 3-ethoxy perfluorinated 2-methyl hexane

### Cure Sites & Optional Modifying Monomers

At least one of the fluoropolymer comprises halogen cure sites. When the second crystalline fluoropolymer is not present, the first amorphous fluoropolymer comprises the halogen cure sites. When the second crystalline fluoropolymer is present, the first and/or second fluoropolymer may comprise the halogen cure sites. The fluoropolymer film or composition may optionally comprise a fluoropolymer comprising non-halogen cure sites, such as nitrile cure sites. Cure sites are typically functional groups that react in the presence of a curing agent or a curing system to crosslink the polymers. However, in the present invention the halogen cure site contributes to improved bonding. In typical embodiments, the amorphous fluoropolymer with halogen cure sites is not chemically crosslinked such that after heating the fluoropolymer remains soluble in fluorinated solvent, such as 3-ethoxy perfluorinated 2-methyl hexane and 3-methoxy perfluorinated 4-methyl pentane, at a concentration of 10 wt. % fluoropolymer.

The cure sites are typically introduced by copolymerizing cure-site monomers, which are functional comonomers already containing the cure sites or precursors thereof. The cure sites may be introduced into the polymer by using cure site monomers, i.e. functional monomers as will be described below, functional chain-transfer agents and starter molecules. The fluoroelastomers may contain cure sites that are reactive to more than one class of curing agents.

The curable fluoroelastomers may also contain cure sites in the backbone, as pendent groups, or cure sites at a terminal position. Cure sites within the fluoropolymer backbone can be introduced by using a suitable cure-site monomer. Cure site monomers are monomers containing one or more functional groups that can act as cure sites or contain a precursor that can be converted into a cure site.

In some embodiments, the cure sites comprise iodine or bromine atoms.

Iodine-containing cure site end groups can be introduced by using an iodine-containing chain transfer agent in the polymerization. Iodine-containing chain transfer agents will be described below in greater detail. Halogenated redox systems as described below may be used to introduce iodine end groups.

In addition to iodine cures sites, other cure sites may also be present, for example Br-containing cure sites or cure sites containing one or more nitrile groups. Br-containing cure sites may be introduced by Br-containing cure-site monomers.

Examples of cure-site comonomers include for instance:
(a) bromo- or iodo-(per)fluoroalkyl-(per)fluorovinylethers, for example including those having the formula:

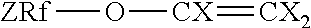

wherein each X may be the same or different and represents H or F, Z is Br or I, Rf is a C1-C12 (per)fluoroalkylene, optionally containing chlorine and/or ether oxygen atoms. Suitable examples include ZCF₂—O—CF═CF₂, ZCF₂CF₂—O—CF═CF₂, ZCF₂CF₂CF₂—O—CF═CF₂, CF₃CFZCF₂—O—CF═CF₂ or ZCF₂CF₂—O—CF₂CF₂CF₂—O—CF═CF₂ wherein Z represents halogen (e.g. Br or I); and
(b) bromo- or iodo perfluoroolefins such as those having the formula:

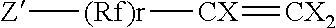

wherein each X independently represents H or F, Z′ is Br or I, Rf is a C₁-C₁₂ perfluoroalkylene, optionally containing chlorine atoms and r is 0 or 1; and
(c) non-fluorinated bromo and iodo-olefins such as vinyl bromide, vinyl iodide, 4-bromo-1-butene and 4-iodo-1-butene.

Specific examples include but are not limited to compounds according to (b) wherein X is H, for example compounds with X being H and Rf being a C1 to C3 perfluoroalkylene. Particular examples include: bromo- or iodo-trifluoroethene, 4-bromo-perfluorobutene-1, 4-iodo-perfluorobutene-1, or bromo- or iodo-fluoroolefins such as 1-iodo,2,2-difluroroethene, 1-bromo-2,2-difluoroethene, 4-iodo-3,3,4,4,-tetrafluorobutene-1 and 4-bromo-3,3,4,4-tetrafluorobutene-1; 6-iodo-3,3,4,4,5,5,6,6-octafluorohexene-1.

In some embodiments, the cure sites comprise chlorine atoms. Such cure-site monomers include those of the general formula: CX₁X₂═CY₁Y₂ where X₁, X₂ are independently H and F; Y₁ is H, F, or Cl; and Y₂ is Cl, a fluoroalkyl group (R_{F}) with at least one Cl substiuent, a fluoroether group (OR_{F}) with at least one Cl substituent, or —CF₂—OR_{F}. The fluoroalkyl group (R_{F}) is typically a partially or fully fluorinated C₁-C₅ alkyl group. Examples of cure-site monomer with chlorine atoms include CF₂═CFCl, CF₂═CF—CF₂Cl, CF₂═CF—O—(CF₂)ₙ—Cl, n=1-4; CH₂═CHCl, CH₂═CCl₂.

In other embodiments, halogenated chain transfer agents can be utilized to provide terminal cure sites. Chain transfer agents are compounds capable of reacting with the propagating polymer chain and terminating the chain propagation. Examples of chain transfer agents reported for the production of fluoroelastomers include those having the formula RIₓ, wherein R is an x-valent fluoroalkyl or fluoroalkylene radical having from 1 to 12 carbon atoms, which, may be interrupted by one or more ether oxygens and may also contain chlorine and/or bromine atoms. R may be Rf and Rf may be an x-valent (per)fluoroalkyl or (per)fluoroalkylene radical that may be interrupted once or more than once by an ether oxygen. Examples include alpha-omega diiodo alkanes, alpha-omega diiodo fluoroalkanes, and alpha-omega diiodoperfluoroalkanes, which may contain one or more catenary ether oxygens. “Alpha-omega” denotes that the iodine atoms are at the terminal positions of the molecules. Such compounds may be represented by the general formula X—R—Y with X and Y being I and R being as described above. Specific examples include di-iodomethane, alpha-omega (or 1,4-) diiodobutane, alpha-omega (or 1,3-) diiodopropane, alpha-omega (or 1,5-) diiodopentane, alpha-omega (or 1,6-) diiodohexane and 1,2-diiodoperfluoroethane. Other examples include fluorinated di-iodo ether compounds of the following formula:

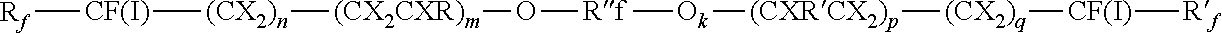

wherein X is independently selected from F, H, and Cl; R_{f} and R′_{f} are independently selected from F and a monovalent perfluoroalkane having 1-3 carbons; R is F, or a partially fluorinated or perfluorinated alkane comprising 1-3 carbons; R″_{f} is a divalent fluoroalkylene having 1-5 carbons or a divalent fluorinated alkylene ether having 1-8 carbons and at least one ether linkage; k is 0 or 1; and n, m, and p are independently selected from an integer from 0-5, wherein, n plus m at least 1 and p plus q are at least 1.

Typically, the amount of iodine or bromine or chlorine or their combination in the fluoropolymer(s) is typically between 0.001 and 5%, preferably between 0.01 and 2.5%, or 0.1 to 1% or 0.2 to 0.6% by weight with respect to the total weight of the fluoropolymer. In some embodiments, the amount of halogen is at least 0.25, 0.30, or 0.35%. In some embodiments, the halogen is bromine.

In some embodiments, the composition is substantially free of fluoropolymer with nitrile-containing cure sites. In this embodiment, the composition is also typically free of curing agents that react with nitrile groups, yet do not react with halogen cure sites. In other embodiments, the composition may optionally further comprise a fluoropolymer with nitrile-containing cure sites.

Fluoropolymers with nitrile-containing cure sites are known, such as described in U.S. Pat. No. 6,720,360.

Nitrile-containing cure sites may be reactive to other cure systems for example, but not limited to, bisphenol curing systems, peroxide curing systems, triazine curing systems, and especially amine curing systems. Examples of nitrile containing cure site monomers correspond to the following formulae:

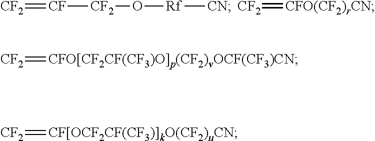

wherein, r represents an integer of 2 to 12; p represents an integer of 0 to 4; k represents 1 or 2; v represents an integer of 0 to 6; u represents an integer of 1 to 6, Rf is a perfluoroalkylene or a bivalent perfluoroether group. Specific examples of nitrile containing fluorinated monomers include but are not limited to perfluoro (8-cyano-5-methyl-3,6-dioxa-1-octene), CF₂═CFO(CF₂)₅CN, and CF₂═CFO(CF₂)₃OCF(CF₃)CN.

In some embodiments, the amount of nitrile-containing cure site comonomer is typically at least 0.5, 1, 1.5, 2, 2.5, 3, 3.5, 4, 4.5 or 5% by weight and typically no greater than 10% by weight; based on the total weight of the fluoropolymer.

Suitable curing agents for nitrile cure sites are known in the art and include, but are not limited to, (e.g. fluorinated) amidines, amidoximes and others described in WO2008/094758 A1, incorporated herein by reference. Representative curing agents include for example bis-tetraphosphonium perfluoroadipate, methyl sulfone, tetrabutyl phosphonium toluy-hexafluoroisopropoxyde trifluoromethoxy, and tetrafluoropropyl amidine.

In one embodiment, the fluoropolymer with nitrile-containing cure sites can be combined with a peroxide and ethylenically unsaturated compound as curing agents as described in WO 2018/107017. In this embodiments, suitable organic peroxides are those which generate free radicals at curing temperatures. Examples include dialkyl peroxides or bis(dialkyl peroxides), for example, a di-tertiary butyl peroxide having a tertiary carbon atom attached to the peroxy oxygen. Specific examples include 2,5-dimethyl-2,5-di(tertiarybutylperoxy)hexyne-3 and 2,5-dimethyl-2,5-di(tertiarybutylperoxy)hexane; dicumyl peroxide, dibenzoyl peroxide, tertiary butyl perbenzoate, alpha,alpha′-bis(t-butylperoxy-diisopropylbenzene), and di[1,3-dimethyl-3-(t-butylperoxy)-butyl]carbonate. Generally, about 1 to 5 parts of peroxide per 100 parts of fluoropolymer may be used.

Notably some of the suitable curing agents for nitrile cure sites also function as bonding agents for halogen-containing fluoropolymers. Others bonding agents will subsequently be described.

The fluoropolymers may or may not contain units derived from at least one modifying monomer. The modifying monomers may introduce branching sites into the polymer architecture. Typically, the modifying monomers are bisolefins, bisolefinic ethers or polyethers. The bisolefins and bisolefinic (poly)ethers may be perfluorinated, partially fluorinated or non-fluorinated. Preferably they are perfluorinated. Suitable perfluorinated bisolefinic ethers include those represented by the general formula:

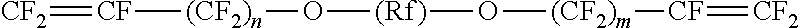

wherein n and m are independent from each other either 1 or 0 and wherein Rf represents a perfluorinated linear or branched, cyclic or acyclic aliphatic or aromatic hydrocarbon residue that may be interrupted by one or more oxygen atoms and comprising up to 30 carbon atoms. A particular suitable perfluorinated bisolefinic ether is a di-vinylether represented by the formula:

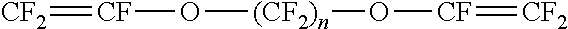

wherein n is an integer between 1 and 10, preferably 2 to 6., e.g. n may be 1, 2, 3, 4, 5, 6 or 7. More preferably, n represents an uneven integer, for example 1, 3, 5 or 7.

Further specific examples include bisolefinic ethers according the general formula

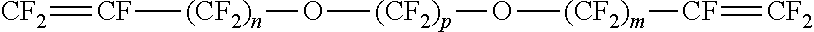

wherein n and m are independently either 1 or 0 and p is an integer from 1 to 10 or 2 to 6. For example, n may be selected to represent 1, 2, 3, 4, 5, 6 or 7, preferably, 1, 3, 5 or 7.

Further suitable perfluorinated bisolefinic ethers can be represented by the formula

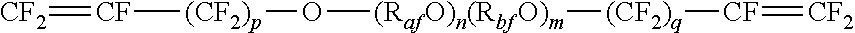

wherein R_{af} and R_{bf} are different linear or branched perfluoroalkylene groups of 1-10 carbon atoms, in particular, 2 to 6 carbon atoms, and which may or may not be interrupted by one or more oxygen atoms. R_{af} and/or R_{bf} may also be perfluorinated phenyl or substituted phenyl groups; n is an integer between 1 and 10 and m is an integer between 0 and 10, preferably m is 0. Further, p and q are independently 1 or 0.

In another embodiment, the perfluorinated bisolefinic ethers can be represented by the formula just described wherein m, n, and p are zero and q is 1-4.

Modifying monomers can be prepared by methods known in the art and are commercially available, for example, from Anles Ltd., St. Petersburg, Russia.

Preferably, the modifiers are not used or only used in low amounts. Typical amounts include from 0 to 5%, or from 0 to 1.4% by weight based on the total weight of the fluoropolymer. Modifiers may be present, for example, in amounts from about 0.1% to about 1.2% or from about 0.3% to about 0.8% by weight based on the total weight of fluoropolymer. Combinations of modifiers may also be used.

### Fluoropolymer Preparation and Other Optional Comonomers

The (e.g. amorphous and crystalline) fluoropolymers can be prepared by methods known in the art, such as bulk, suspension, solution or aqueous emulsion polymerization. (See for example EP 1,155,055; U.S. Pat Nos. 5,463,021; 5,285,002; 5,623,038; WO 2015/088784 and WO 2015/134435) Further, several (e.g. amorphous and crystalline) fluoropolymers are commercially available. Various emulsifiers can be used as described in the art, including for example 3H-perfluoro-3-[(3-methoxy-propoxy)propanoic acid. For example, the polymerization process can be carried out by free radical polymerization of the monomers alone or as solutions, emulsions, or dispersions in an organic solvent or water. Seeded polymerizations may or may not be used.

The (e.g. amorphous and crystalline) fluoropolymers may have a monomodal or bi-modal or multi-modal weight distribution. The fluoropolymers may or may not have a core-shell structure. Core-shell polymers are polymers where towards the end of the polymerization, typically after at least 50% by mole of the comonomers are consumed, the comonomer composition or the ratio of the comonomers or the reaction speed is altered to create a shell of different composition.

The (e.g. amorphous and crystalline) fluoropolymers may contain partially fluorinated or non-fluorinated comonomers and combinations thereof, although this is not preferred. Typical partially fluorinated comonomers include but are not limited to 1,1-difluoroethene (vinylidenefluoride, VDF), hexafluoropropylene (HFP), and vinyl fluoride (VF) or trifluorochloroethene or trichlorofluoroethene. Examples of non-fluorinated comonomers include but are not limited to ethene and propene. The amount of units derived from these partially fluorinated or non-fluorinated comonomers may range from 0 to 15% wt. % based on the total weight of the fluoropolymer. In typical embodiments, the fluoropolymer composition comprises no greater than 14, 13, 12, 11, 10, 9, 8, 7, 6, 5, 4, 3, 2, 1 or 0.1 wt.-% of polymerized units derived from non-fluorinated or partially fluorinated monomers based on the total weight of the fluoropolymer. In some embodiments, the fluoropolymer comprises no greater than 5, 4, 3, 2, 1 or 0.1, 0.01 wt. % of ester-containing linkages, including (meth)acrylate groups. The presence of partially fluorinated or non-fluorinated comonomers including those with ester-containing linkages can increase the dielectric properties.

### Bonding Agents

The fluoropolymer film and coating compositions described herein comprises one or more compounds that may be characterized as bonding agents. The bonding agent compound(s) comprises an electron donor group and one or more unsaturated groups or in other words a double or triple bond.

The unsaturated group(s) are typically ethylenically unsaturated groups including (meth)acryl including (meth)acrylate RCH═CHCOO— and (meth)acrylamide RCH═CHCONH—, wherein R is methyl of hydrogen; alkenyl (i.e. vinyl, CH₂═CH—); and alkynyl. The unsaturated group may also be a halide thereof, i.e. wherein one or more halogen atoms are bonded to an unsaturated double bond (typically in place of hydrogen).

The ethylenically unsaturated compound may be linear, branched, or comprise a cyclic group. The ethylenically unsaturated compounds may be aliphatic or aromatic. In some embodiments, the ethylenically unsaturated compound is (e.g. nitrogen-containing) heterocyclic compound, such as in the case of cyanurates and isocyanurates.

In some embodiments, a single compound comprises an electron donor group and an (e.g. ethylenically) unsaturated group(s) such as in the case of an aminoalkene, and vinylaniline

In other embodiments, the fluoropolymer film and coating compositions comprises a first bonding agent comprising an unsaturated group and a second bonding agent comprising an electron donor group. The combination of electron donor group and unsaturated group contributes to adhesion to metal, such as copper.

In typicaly embodiments, the bonding agent comprising an unsaturated group comprises 2, 3, or 4 (e.g. ethylenically) unsaturated groups. In some embodiments, the bonding agent comprising an unsaturated group comprises no greater than 6, 5, 4, or 3, or 4 (e.g. ethylenically) unsaturated groups.

Although various (meth)acrylate compounds (such as the multi-(meth)acrylate compounds described in WO2021/091864; incorporated herein by reference) are suitable for increasing adhesion, such compounds are typically less preferred with respect to obtaining low Dk and Df values.

In typical embodiments, the (e.g. ethylenically) unsaturated compound(s) comprise alkenyl (i.e. vinyl, CH₂═CH—) groups. Examples include triallyl cyanurate; triallyl isocyanurate; triallyl trimellitate; tri(methylallyl)isocyanurate; tris(diallylamine)-s-triazine; triallyl phosphite; (N,N′)-diallyl acrylamide; hexaallyl phosphoramide; (N,N,N,N)-tetraalkyl tetraphthalamide; (N,N,N′,N-tetraallylmalonamide; trivinyl isocyanurate; N,N′-m-phenylenebismaleimide; diallyl-phthalate and tri(5-norbornene-2-methylene)cyanurate. Illustrative compounds include triallyl isocyanurate (TAIC), xylene bis(diallyl isocyanurate) and 1,3,4,6-tetraallylglycoluril.

In some embodiments, the (e.g. ethylenically) unsaturated compound comprises a silicone-containing moiety such as silane or siloxane. Suitable ethylenically unsaturated compounds that comprise silicone-containing moieties include for example diallydimethylsilane; allyltrimethoxysilane; and 1,3-divinyltetramethyl disiloxane, as well as vinylsilsesquioxane.

In some embodiment, the bonding agent compound comprises at least one (e.g. ethylenically) unsaturated group and at least one alkoxy silane group.

In some embodiments, the (e.g. ethylenically) unsaturated compound may have the general formula

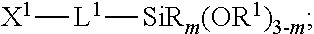

wherein X¹ is an (e.g. ethylenically) unsaturated group;
L¹ is an organic divalent linking group having 1 to 12 carbon atoms;
R is independently C₁-C₄ alkyl and most typically methyl or ethyl;
R¹ is independently H or C₁-C₄ alkyl and most typically methyl or ethyl; and
m ranges from 0 to 2.

In typical embodiments, L¹ is an alkylene group. In some embodiments, L¹ is an alkylene group having 1, 2 or 3 carbon atoms. In other embodiments, L¹ comprises or consists of an aromatic group such as phenyl or (e.g. C₁-C₄) alkyl phenyl.

Suitable compounds include (meth)acryloy alkoxy silanes such as 3-(methacryloxy)propyltrimethoxysilane, 3-(methacryloxy)propylmethyldimethoxysilane, 3-(acryloyloxypropyl)methyl dimethoxysilane, 3-(methacryloyloxy)propyldimethylmethoxysilane, and 3-(acryloxypropyl) dimethylmethoxysilane. More preferred alkenyl alkoxy silanes include, for example, vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, and allyltriethoxysilane.

The fluoropolymer film and composition may comprise a single (e.g. ethylenically) unsaturated compound as just described or combinations of (e.g. ethylenically) unsaturated compounds.

The (e.g. ethylenically) unsaturated compound(s) are typically present in an amount of at least 0.05, 0.1, 0.2, 0.3, 0.4, 0.5, 0.6, 0.8, 0.9, or 1 wt. %. In some embodiments, the amount of (e.g. ethylenically) unsaturated compound(s) is greater than 0.5 in order to prevent the fluoropolymer film from blistering when heated to 288° C. for 10-15 minutes. The maximum amount of (e.g. ethylenically) unsaturated compound(s) is typically no greater than 10, 9, 8, 7, 6, 5, 4, 3, or 2 wt. % based on the total weight of the fluoropolymer. Typically, the fluoropolymer film or composition comprises the least amount of (e.g. ethylenically) unsaturated compound(s) that provides the desired improved in adhesion (e.g. at elevated temperatures). In many embodiments, good adhesion was obtained at concentrations no greater than 5, 4, 3, 2, or 1 wt. %. based on the total weight of the fluoropolymer.

### Compound Comprising an Electron Donor Group

The fluoropolymer film and composition described herein further comprises an electron donor group or precursor thereof. Electon donor compounds as also referred to an reducing agents, whereas electron acceptors are also referred to an oxidizing agent. Organic electron donors (OEDs) are neutral or ionic, ground state organic molecules that are surmised to reduce the halogen atoms of the fluoropolymers by single electron transfer. Electron donor compounds typically contain lone paired electron atoms including N, O, P, S and electron rich conjugated Pi bonds like aromatic rings.

In some emboidments, a single compound comprises an electron donor group and an (e.g. ethylenically) unsaturated group(s) as previously described. In other embodiments. the fluoropolymer film and coating compositions comprises a first bonding agent comprising an unsaturated group and a second bonding agent comprising an electron donor group.

Various electon donor groups are known from the literature. Representative electron donor groups include, for example, oxido, amine, hydroxy, alkoxy, acrylamide, phosphine, thiol, mercapto, aryl, or combinations thereof. In some embodiments, the electron donor compound comprises two or more electron donor groups. For example, phenol include both an aryl group and a hydroxy group. The structure and relative strength of some of such electron donor groups are described as follows:

| Magnitude of | Substituent Name (in approximate | |
|---|---|---|
| activation | order of activating strength | Structure |
| Extreme | oxido group | —O⁻ |
| Strong | (substituted)amino groups | —NH₂ |
| | | —NHR |
| | | —NR₂ |
| | hydroxy and alkoxy groups | —OH |
| | | —OR |
| Moderate | acylamido groups | —NHCOR |
| | acyloxy groups | —OCOR |
| | (di)alkylphosphino, | —PR₂ |
| | alkylthio, and sulfhydryl | —SR |
| | groups | —SH |
| Weak | phenyl (or aryl) group | C₆H₅ |
| | vinyl group | —CH═CH₂ |
| | alkyl groups | -R |
| | (e.g. —CH₃, —C₂H₅) | |
| | carboxylate group | —CO₂⁻ |

Of these electon donor groups, acyloxy is typically less preferred due to comprising ester groups. Electron donor group with moderate, strong or extreme activation are typically preferred. Weak electron donor groups, with the exception of aryl (e.g. xylene), are typically not suitable. For example, it has been found that compounds with vinyl groups (e.g. TAIC) do not typically provide suitable adhesion alone, in the absence of a moderate or strong electon donor group. In favored embodiments, the bonding agnet compounds are soluble or dispersible in fluroinated solvent. Thus, compounds with carboxylate groups are less preferred due to lack of solubility in fluorinated solvent, whereas fluorinated electron donors can be more preferred with respect to solubility.

Electron donor compounds can also be categorized with respect to their reduction potential. The reduction potential E/mV (e.g. ArO+/ArO−) of various compounds is reported in the literature (e.g. Reduction Potentials of One-Electron Couples Involving Free Radicals in Aqueous Solution Cite, Journal of Physical and Chemical Reference Data 18, 1637 (1989); Published Online: 15 Oct. 2009) The reduction potential of some representative compounds at a neutral pH (i.e. 7) are as follows: phenol=800 E/mV; 1,2-dihydroxybenzene=530 E/mV; 1,4-dihydroxybenzene=459 E/mV; aniline=1030 E/mV; and 4-aminophenol=410 E/mV.

In some embodiments, the electon donor group or electron donor compound has a reduction potential of at least 100, 200, 300, or 400 E/mV. In some embodiments, the electon donor group or electron donor compound has a reduction potential of no greater than 1200, 1150, or 1100 E/mV. Such reduction potentials are at standard temperature (0° C., 32° F.) and a neutral pH. However, it is known that Gibbs free energy change of reaction is dependent on temperature, implying that redox potentials changed as a function of temperature. Thus, preferred compounds include those having the described reduction potentials at the bonding temperature, rather than standard temperature. It is surmised that many compounds have higher reduction potentials at higher temperatures than the redeuction potential at standard temperature reported in the literature.

As described in WO2021/091864 upon exposure to suitable wavelengths and intensities of actinic (e.g. UV) radiation the halogen atoms of the cure sites of the fluoropolymer become excited and ionize. The ionized halogen atoms react with the electron donor group rendering an electron poor radical cure sites in place of the former halogen atoms. Such radical species can attack the ethylenically unsaturated group(s) to form covalent bonds. However, an aspect of the present invention is that the fluoropolymer film, that may be derived from a dried coating solution. is heated to a suitably high temperature (150-200° C. or higher) in the absence of exposure to ultraviolet radiation. In other words, the method typicall lacks exposing the fluoropolymer film to ultraviolet radiation. Thus, chemical crosslinking of the halogenated fuoropolymer typically does not occur. Chemical crosslinking may be evidenced by the heated amorphous fluoropolymer being soluble in fluorinated solvent at a concentration of at least 10 wt. %.

Without being bound by theory, it is surmised that that halogen atoms of the fluoropolymer and electron donor may participate in thermally induced oxidation-reduction chemistry, or in otherwords a thermally induced electron transfer process. If a halogen-containing fluoropolymer electron acceptor, A is reduced to a radical anion, A−, the radical anion may oxidize the electron donor (i.e. D) to a D+ radical cation. The oxidation and reduction reactions occurring involving electron transfer between A and D can be calculated from the one-electron reduction potentials EO(A/A−), EO(D/D−).

In some embodiments, the electron donor compound comprises an oxido group. Representative compounds include salts of 4-methyl-α, α-bis(trifluoromethypbenzylmethanol and tetrabutyl phosphonium and 4-methyl-α, α-bis(trifluoromethypbenzylmethanol and tetrabutyl phosphonium.

In some embodiments, the electron donor compound comprises an amine, or precursor thereof. Suitable amines include primary amine, secondary amines, teritiary amines, and combinations thereof. The amine may be aliphatic or aromatic, such as in case of alkyl amines or aryl amines. The electron donor compound may comprise a single amine ranging up to 2, 3, 4, 5, or 6 amine groups. Amine compounds can also be utilized to provide a crosslinked fluoropolymer layer by (e.g. thermally) curing a fluoropolymer with (e.g. nitrile) cure sites utilizing an amine cuing agent. The same compounds can potentially provide good initial adhesion and crosslinking by use of fluoropolymers with both halogen and nitrile cure sites.

Illustrative amine compounds include for example diamino hexane, N,N,N′,N′-tetramethyl-1,4-diamino butane (TMDAB); aniline; N,N-dimethyl aniline; triethylenetetramine; diethylenetriamine; 1,3-bis(dimethylamino)-2-propanol; N-phenylpiperazine; 2-dimethylaminopyridine; 4,4-trimethylene bis(1-methylpiperidene); tetraethylene pentamine.

In some embodiments, the amine groups are spaced apart by an alkylene group having at least 3, 4, 5, or 6 (e.g. carbons) atoms. Typically, the number of (e.g. carbon) atoms is no greater than 12. When the amine compound has an insufficient chain length, it can be a less effective electon donor group. The alkylene group can optionally comprise subsituents, such as siloxane, provided the compound is an electron donor or precursor thereof.

In some embodiments, the electron donor compound may be characterized as an electron donor precursor meaning that when the compound is initially combined with the fluoropolymer it is not an electron donor. However, the precursor compound decomposes or otherwise reacts to form an (e.g. amine) electron donor during heating. For example, electron donor precursors include nitrogen-containing nucleophilic compounds such as heterocyclic secondary amines; guanidines; compounds which decompose in-situ at a temperature between 40° C. and 330° C. to produce a guanidine; compounds which decompose in-situ at a temperature between 40° C. and 330° C. to produce a primary or secondary amine; nucleophilic compounds of the formula R₁—NH—R₂, wherein R₁ is H—, a C₁-C₁₀ aliphatic hydrocarbon group, or an aryl group having hydrogen atoms in the alpha positions, R₂ is a C₁-C₁₀ aliphatic hydrocarbon group, an aryl group having hydrogen atoms in the alpha positions, —CONHR₃, —NHCO₂R₃, or —OH′, and R₃ is a C₁-C₁₀ aliphatic hydrocarbon group; and substituted amidines of the formula HN═CR₄NR₅R₆, wherein R₄, R₅, R₆ are independently H—, alkyl or aryl groups and wherein at least one of R₄, R₅ and Re is not H—.

As used herein, “heterocyclic secondary amine” refers to aromatic or aliphatic cyclic compound having at least one secondary amine nitrogen contained within the ring. Such compounds include, for example, pyrrole, imidazole, pyrazole, 3-pyrroline, and pyrrolidine.

Guanidines are compounds derived from guanidine, i.e. compounds which contain the radical, —NHCNHNH—, such as, but not limited to, diphenylguanidine, diphenylguanidine acetate, aminobutylguanidine, biguanidine, isopentylguanidine, di-o-tolylguanidine, o-tolylbiguanide, and triphenylguanidine.

Other compounds that decompose in-situ at a temperature between 40° C. and 330° C. to produce either a primary or secondary amine include, but are not limited to, di- or poly-substituted ureas (e.g. 1,3-dimethyl urea); N-alkyl or -dialkyl carbamates (e.g. N-(tert-butyloxycarbonyl)propylamine); di- or poly-substituted thioureas (e.g. 1,3-dimethyl-thiourea); aldehyde-amine condensation products (e.g. 1,3,5-trimethylhexahydro-1,3,5-triazine); N,N′-dialkyl phthalamide derivatives (e.g. N,N′-dimethylphthalamide); and amino acids.

Other types of amine electron donor include bis(aminophenols) and bis(aminothiophenols) of the formulas

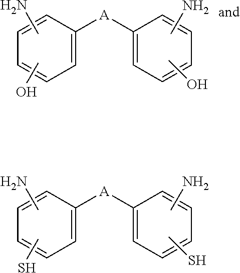

and tetraamines of the formula

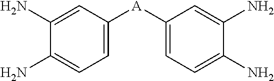

where A is SO₂, O, CO, alkyl of 1-6 carbon atoms, perfluoroalkyl of 1-10 carbon atoms, or a carbon-carbon bond linking the two aromatic rings. The amino and hydroxyl groups in the above formulas are interchangeably in the meta and para positions with respect to group A.

In some embodiments, the amine electron donor compound is an aziridine compound. In some embodiments, the aziridine compound comprises at least two aziridine groups. The aziridine compound may comprise 3, 4, 5, 6, or greater than 6 aziridine groups. The aziridine compound may be represented by the following structure:

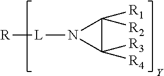

wherein R is a core moiety having a valency of Y;
L is a bond, divalent atom, or divalent linking group;
R₁, R₂, R₃, and R₄ are independently hydrogen or a C₁-C₄ alkyl (e.g. methyl); and
Y is typically 2, 3, or greater.

In some embodiments, R is —SO₂—. In some embodiments, R-L is a residue of a multi(meth)acrylate compound. In some embodiments L is a C₁-C₄ alkylene, optionally substituted with one or more (e.g. contiguous or pendant) oxygen atoms thereby forming ether or ester linkages. In typical embodiments, R₁ is methyl and R₂, R₃, and R₄ are hydrogen.

Representative aziridine compounds include trimethylolpropane tri-[beta-(N-aziridinyl)-propionate, 2,2-bishydroxymethyl butanoltris[3-(1-aziridine) propionate]; 1-(aziridin-2-yl)-2-oxabut-3-ene; and 4-(aziridin-2-yl)-but-1-ene; and 5-(aziridin-2-yl)-pent-1-ene.

In some embodiments, a polyaziridine compound can be prepared by reacting divinyl sulfone with alkylene (e.g. ethylene) imine, such as described in U.S. Pat. No. 3,235,544 (Christena). On representative compound is di(2-propyleniminoethyl)sulfone, as depicted as follows:

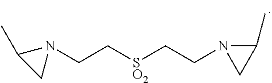

Various other suitable aziridine crosslinkers are known, such as described in WO2014/075246; published May 22, 2014, incorporated herein by reference: and “NEW GENERATION OF MULTIFUNCTIONAL CROSSLINKERS,” (See https://www.pstc.org/files/public/Milker00.pdf).

In some embodiments, the composition comprises an electron donor compound comprising at least one (e.g. primary, secondary, or tertiary) amine group and at least one organosilane (e.g. alkoxy silane) group.

In some embodiments, the amine may be characterized as an amino-substituted organosilane ester or ester equivalent that bear on the silicon atom at least one, and preferably 2 or 3 ester or ester equivalent groups. Ester equivalents are known to those skilled in the art and include compounds such as silane amides (RNR′Si), silane alkanoates (RC(O)OSi), Si—O—Si, SiN(R)—Si, SiSR and RCONR′Si compounds that are thermally and/or catalytically displaceable by R″OH. R and R′ are independently chosen and can include hydrogen, alkyl, arylalkyl, alkenyl, alkynyl, cycloalkyl, and substituted analogs such as alkoxyalkyl, aminoalkyl, and alkylaminoalkyl. R″ may be the same as R and R′, except it may not be H. These ester equivalents may also be cyclic such as those derived from ethylene glycol, ethanolamine, ethylenediamine (e.g. N-[3-(trimethoxylsilyl)propyl] ethylenediamine) and their amides.

Another such cyclic example of an ester equivalent is

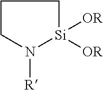

In this cyclic example R′is as defined in the preceding sentence, except that it may not be aryl. 3-aminopropyl alkoxysilanes are well known to cyclize upon heating, and these RNHSi compounds would be useful in this invention. Preferably the amino-substituted organosilane ester or ester equivalent has ester groups such as methoxy that are easily volatilized as methanol. The amino-substituted organosilane must have at least one ester equivalent; for example, it may be a trialkoxysilane.

For example, the amino-substituted organosilane may have the formula (Z₂N-L-SiX′X″X″′), wherein

Z is hydrogen, alkyl, or substituted aryl or alkyl including amino-substituted alkyl; and L is a divalent straight chain C1-12 alkylene or may comprise a C3-8 cycloalkylene, 3-8 membered ring heterocycloalkylene, C2-12 alkenylene, C4-8 cycloalkenylene, 3-8 membered ring heterocycloalkenylene or heteroarylene unit; and each of X′, X″ and X″′ is a C1-18 alkyl, halogen, C1-8 alkoxy, C1-8 alkylcarbonyloxy, or amino group, with the proviso that at least one of X′, X″, and X′″ is a labile group. Further, any two or all of X′, X″ and X′″ may be joined through a covalent bond. The amino group may be an alkylamino group.

L may be divalent aromatic or may be interrupted by one or more divalent aromatic groups or heteroatomic groups. The aromatic group may include a heteroaromatic. The heteroatom is preferably nitrogen, sulfur or oxygen. L is optionally substituted with C1-4 alkyl, C2-4 alkenyl, C2-4 alkynyl, C1-4 alkoxy, amino, C3-6 cycloalkyl, 3-6 membered heterocycloalkyl, monocyclic aryl, 5-6 membered ring heteroaryl, C1-4 alkylcarbonyloxy, C1-4 alkyloxycarbonyl, C1-4 alkylcarbonyl, formyl, C1-4 alkylcarbonylamino, or C1-4 aminocarbonyl. L is further optionally interrupted by —O—, —S—, —N(Rc)-, —N(Rc)-C(O)—, —N(Rc)-C(O)—O—, —O—C(O)—N(Rc)-, —N(Rc)-C(O)—N(Rd)-, —O—C(O)—, —C(O)—O—, or —O—C(O)—O—. Each of Rc and Rd, independently, is hydrogen, alkyl, alkenyl, alkynyl, alkoxyalkyl, aminoalkyl (primary, secondary or tertiary), or haloalkyl.

Examples of amino-substituted organosilanes include 3-aminopropyltrimethoxysilane (SILQUEST A-1110), 3-aminopropyltriethoxysilane (SILQUEST A-1100), bis(3-trimethoxysilylpropy)amine, bis(3-triethoxysilylpropy)amine, bis(3-trimethoxysilylpropy)n-methylamine, 3-(2-aminoethyl)aminopropyltrimethoxysilane (SILQUEST A-1120), SILQUEST A-1130, (aminoethylaminomethyl)phenethyltrimethoxysilane, (aminoethylaminomethyl)-phenethyltriethoxysilane, N-(2-aminoethyl)-3-aminopropylmethyldimethoxysilane (SILQUEST A-2120), bis-(.gamma.-triethoxysilylpropyl)amine (SILQUEST A-1170), N-(2-aminoethyl)-3-aminopropyltributoxysilane, 6-(aminohexylaminopropyl)trimethoxysilane, 4-aminobutyltrimethoxysilane, 4-aminobutyltriethoxysilane, p-(2-aminoethyl)phenyltrimethoxysilane, 3-aminopropyltris(methoxyethoxyethoxy)silane, 3-aminopropylmethyldiethoxy-silane, oligomeric aminosilanes such as DYNASYLAN 1146, 3-(N-methylamino)propyltrimethoxysilane, N-(2-aminoethyl)-3-aminopropylmethyldimethoxysilane, N-(2-aminoethyl)-3-aminopropylmethyldiethoxysilane, N-(2-aminoethyl)-3-aminopropyltrimethoxysilane, N-(2-aminoethyl)-3-aminopropyltriethoxysilane, 3-aminopropylmethyldiethoxysilane, 3-aminopropylmethyldimethoxysilane, 3-aminopropyldimethylmethoxysilane, 3-aminopropyldimethylethoxysilane, and the following cyclic compounds:

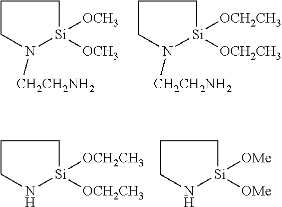

A bis-silyl urea [RO)₃Si(CH₂)NR]₂C═O is another example of an amino-substituted organosilane ester or ester equivalent.

Other amino-substituted organosilane ester or ester equivalent having latent functionality are known from previously cited WO2021/091864.

Other amino-substituted organosilane ester or ester equivalent include N,N-dimethyl-3-aminopropyltrimethoxysilane; N-phenylaminomethyltriethoxysilane N-phenylaminopropyltrimethoxysilane; aminopropyl terminated polydimethyl siloxane; bis-[3-(trimethoxysilyl)-propyl]-amine: N-[3-(trimethoxysilyl)propyl] ethylenediamine; and 2-(4-pyridylethyl)triethoxysilane.

In some emboidments, the electron donor compound is a fluorinated electron donor, such as a fluorinated amine compound. Florinated electron donor compounds can advantageously be soluble in the flurorinated solvent and to compatible with fluoropolymers. Various fluorinated amine compounds are described in PCT/IB2022/053074; incorporated herein by reference.

In some embodiments, the fluorinated amine curing agent has the formula:

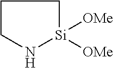

wherein:
Rf is a (per)fluorinated group;
L¹ is a divalent linking group or a covalent bond;
R¹ is independently hydrogen, an alkyl group having from 1 to 8 carbon atoms, an aminoalkyl group having from 2 to 8 carbon atoms, a hydroxyalkyl group having from 2 to 8 carbon atoms, or -L¹Rf;
R² independently represents an alky lene group having from 2 to 8 carbon atoms;
R³ is hydrogen, an alkyl group having 1 to 4 carbon atoms, or -L¹Rf;
n is at least 1; and
p is 1 or two.

In some embodiments, the perfluroinated moiety, Rf, is HFPO—, defined as a perfluoropolyether group, F(CF(CF₃)CF₂O)ₙCF(CF₃)— where n averages at least 2, 3, 4, 5 or 6 and typically average no greater than 12, 10, 11, 9, 8, 7, or 6. In other embodiments, Rf is a divalent —HFPO— group defined as —(CF(CF₃)CF₂O)ₙCF(CF₃)— where n+o averages at least 2, 3, 4, 5 or 6 and typically average no greater than 12, 10, 11, 9, 8, 7, or 6. The monovalent or divalent HFPO group typically has a weight average molecular weight of at least 800, 900, 1000, 1000 or 1200 g/mole and typically no greater than 5000 g/mole. In some embodiments, HFPO— group has a weight average molecular weight of no greater than 4500, 4000, 3500, 3000, 2500, 2000, or 1500 g/mole.

In some embodiments, L¹ is a divalent linking group such as alky lene (e.g. methylene, ethylene), arylene, —C(O)—, —SO₂— or a combination thereof. The alkylene group may further comprise sulfur or oxygen atoms including hydroxyl substituents.

In typical embodiments, at least one R¹ or R³ group is hydrogen. In some emboidments, each R¹ is hydrogen. In other words the fluroinated curing agent comprises one or more primary amine groups. Primary amine groups can be preferred for curing at lower temperatures.

In typical embodiments, one or more R² groups is an alkylene group having 1 to 4 carbon atoms such as —CH₂CH₂ —.

In some embodiments, n is at least 1 or 2. In some embodiments, n is no greater than 6, 5, 4, or 3.

Representative compounds wherein R³ is —C(O)Rf include for example Rf-CONHCH₂CH₂NHCH₂CH₂NHC(O)-Rf, Rf-CONH[CH₂CH₂NH]₂CH₂CH₂NHC(O)-Rf, and RfCONH[CH₂CH₂NH]₄C(O)Rf.

A representative compound wherein R³ is —NR¹ is Rf-CO(NHCH₂CH₂)NH₂. Other representative compounds include Rf-CONHCH₂CH₂NHCH₂CH₂NH₂, Rf-SO₂NHCH₂CH₂NHCH₂CH₂NHSO₂-Rf, Rf-SO₂NH[CH₂CH₂NH]₂CH₂CH₂NHSO₂-Rf, Rf-SO₂NHCH₂CH₂NHCH₂CH₂NH₂, Rf-CH₂NHCH₂CH₂NHCH₂-Rf, Rf-CH₂NH[CH₂CH₂NH]₂CH₂CH₂NHCH₂-Rf, Rf-CH₂NHCH₂CH₂NHCH₂CH₂NH₂, Rf-CH₂CH₂NHCH₂CH₂NHCH₂CH₂NHCH₂CH₂-Rf, Rf-CH₂CH₂NH[CH₂CH₂NH]₂CH₂CH₂NHCH₂CH₂-Rf, Rf-CH₂CH₂NHCH₂CH₂NHCH₂CH₂NH₂, Rf-CONHCH₂CHMeNHCH₂CH₂NHC(O)-Rf, Rf-CONH[CH₂CHMeNH]₂CH₂CH₂NHC(O)-Rf, Rf-CONHCH₂CHMeNHCH₂CHMeNH₂, Rf-SO₂NHCH₂CHMeNHCH₂CH₂NHSO₂-Rf, Rf-SO₂NH[CH₂CHMeNH]₂CH₂CH₂NHSO₂-Rf, Rf-SO2NHCH₂CHMeNHCH₂CH₂NH₂, Rf-CH₂ NHCH₂CHMeNHCH₂-Rf, Rf-CH₂NH[CH₂CHMeNH]₂CH₂CH₂NHCH₂-Rf, Rf-CH₂NHCH₂CHMeNHCH₂CH₂NH₂, Rf-CH—CH₂NHCH₂CHMeNHCH₂CH₂NHCH₂CH₂-Rf, Rf-CH₂CH₂NH[CH₂CHMeNH]₂CH₂CH₂NHCH₂CH₂-Rf, and RfCH₂CHMeNHCH₂CH₂NHCH₂CH₂NH₂.

In other embodiments, the electon donor compound is an alkoxy silane compound that lacks amine functionality. Such compounds have the general formula:

R²ₙSi(OR¹)ₘ
wherein R¹ is independently alkyl as previously described;
R² is independently hydrogen, alkyl, aryl, alkaryl, or OR¹;
n is 1 to 3; and
m ranges from 1 to 3, and is typically 2 or 3 as previously described.

Suitable alkoxy silanes of the formula R²Si(OR¹)ₘ include, but are not limited to tetra-, tri- or dialkoxy silanes, and any combinations or mixtures thereof. Representative alkoxy silanes include propyltrimethoxysilane, propyltriethoxysilane, butyltrimethoxysilane, butyltriethoxysilane, pentyltrimethoxysilane, pentyltriethoxysilane, heptyltrimethoxysilane, heptyltriethoxysilane, octyltrimethoxysilane, octyltriethoxysilane, dodecyltrimethoxysilane, dodecyltriethoxysilane, hexadecyltrimethoxysilane, hexadecyltriethoxysilane, octadecyltrimethoxysilane, octadecyltriethoxysilane, phenyltrimethoxysilane, phenyltriethoxysilane, phenylmethyl dimethoxysilane, dimethyldimethoxysilane and dimethyldiethoxysilane.

In typical embodiments, R¹ an alkyl group having 1 to 4 carbon atoms with methoxy and ethoxy most typical.

R² may comprise 1 to 24 carbon atoms.

When R² comprises (substituted) aryl, such as phenyl, such compounds comprise an aryl (e.g. phenyl) electron donor group. Alkoxy groups are also described as strong electron donor groups.

Alkoxy silanes wherein R² is OR¹ include tetra methoxysilane, tetra ethoxysilane (TEOS), methyl triethoxysilane, dimethyldiethoxysilane, partially hydrolyzed tetramethoxysilane (TMOS) (available from Mitsuibishi Chemical Company under the trade designation “MS-51”) and mixtures thereof.

Other sulfur-containing electron donor groups, include aliphatic and aromatic thiols and mercapto compounds.

In some embodiments, the electron donor compound comprises an (e.g. alkyl or aryl) phosphino group. Representative compounds include for example and tri-n-butylphosphine; tri-n-butyl ester phosphite; as well as salts of 4-methyl-α, α-bis(trifluoromethypbenzylmethanol and tetrabutyl phosphonium and 4-methyl-α, α-bis(trifluoromethypbenzylmethanol and tetrabutyl phosphonium as described in US20220033634; incorporated herein by reference.

The composition comprises a single electron donor compound or a combination of electron donor compounds. The amount of electron donor compound is typically at least 0.01, 0.02, 0.03, 0.04, 0.05, 0.06, 0.07, 0.08, 0.09, 0.1, 0.2, 0.3, 0.4, or 0.5 wt. % solids (i.e. excluding the solvent of the coating composition). In some embodiments, the amount of (e.g. amine) electron donor compound is no greater than 5, 4.5, 4, 3.5, or 3 wt. % solids.

### Coagulated Fluoropolymers and Properties

In some embodiments, the first (e.g. amorphous) fluoropolymer is obtained by coagulating a latex or co-coagulating a blend of amorphous and crystalline fluoropolymer latexes. In another embodiment, the amorphous fluoropolymer latex particles can be coagulated, washed, and dried separately from the latex containing crystalline fluoropolymer particles. The fluoropolymer latex particles can be dry blended with the dried amorphous fluoropolymer particles, as described in WO2020/132203.

The latexes can be combined by any suitable manner such as by vortex mixing for 1-2 minutes. Coagulation may be carried out, for example, by chilling (e.g., freezing) the individual or blended latexes or by adding a suitable coagulating agent including salts (e.g., magnesium chloride) or inorganic acid (e.g. nitric acid). When coagulated by chilling, there is no residual coagulating agent. The method further comprising optionally washing the coagulated fluoropolymer or mixture of fluoropolymers. The washing step may substantially remove emulsifiers or other surfactants from the mixture and can assist in obtaining a well-mixed blend of substantially unagglomerated dry particles. In some embodiments, the surfactant level of the resulting dry particle mixture may, for example, be less than 0.1% by weight, less than 0.05% by weight or less than 0.01% by weight. The method further comprises drying the coagulated latex. The coagulated latex can be dried by any suitable means such as air drying or oven drying. Some suitable drying conditions are described in the forthcoming examples. Insufficient drying can result in higher Dk and Df properties.

When the amorphous and crystalline fluoropolymer are a co-coagulated latex mixture, the fluoropolymer can be physically crosslinked. One indication of physical crosslinking is that the amount of fluoropolymer that is insoluble in fluorinated solvent (e.g. 3-ethoxy perfluorinated 2-methyl hexane or 3-ethoxy perfluorinated 2-methyl hexane) is greater than the amount of second crystalline fluoropolymer. Conversely, the amount of fluoropolymer that is soluble in fluorinated solvent is less than the amount of first (e.g. amorphous) fluoropolymer.

As described in PCT/IB2022/053284, incorporated herein by reference, when the amorphous fluoropolymer alone (i.e. without the dispersed crystalline fluoropolymer particles) is heated to temperatures of 150, 200, or 300° C. the amorphous fluoropolymer remains soluble in fluorinated (e.g. HFE-7500) solvent. However, when the amorphous fluoropolymer together with the dispersed crystalline fluoropolymer particles is heated to temperatures at or above the melting temperature of the second crystalline fluoropolymer, the composition becomes insoluble in fluorinated (e.g. HFE-7500) solvent. Without intending to be bound by theory, it is surmised that the TFE units of the crystalline fluoropolymer particles co-crystallize or otherwise interact with the TFE units of the amorphous fluoropolymer, thereby (e.g. physically) crosslinking the amorphous fluoropolymer. In this embodiment, the fluoropolymer layer of the coated substrate or article may be characterized as “physically crosslinked”.

In another embodiment, the physically crosslinked fluoropolymer composition can have a normalized crystallinity of greater than 100%. In some embodiments, the normalized crystallinity may range up to 105, 110, 115, 120, 125, 130, 135, 140, 145, 150, 155, or 160%.

A normalized crystallinity of a blend of a crystalline fluoropolymer and an amorphous fluoropolymer can be calculated by the following equation: [delta H of a blend of fluoropolymers/(delta H of the crystalline fluoropolymer (i.e. alone) multiplied by the wt. % of such fluoropolymer in the blend)*100]. The delta H can be deteremined via Differenential Scanning calorimetry utilizing a heat-cool-heat method in temperature modulated mode (−50 to 350° C. at 10° C./minute).

Alternatively, when amorphous and crystalline fluoropolymer particles are dry blended and melted, the fluoropolymer composition typically has a normalized crystallinity of less than 100%. The normalized crystallinity may be at least 70 or 75%.

As also described in PCT/IB2022/053284, in some embodiments, the fluoropolymer composition has a higher (e.g. first cycle) tan delta at a temperature in a range from 100° C. to a temperature below the melt temperature of the fluoropolymer(s) than the same fluoropolymer composition further comprising crosslinks of a chemical curing agent. In some embodiments, the fluoropolymer composition has a lower (e.g. first cycle) storage modulus at a temperature in a range from 100° C. to a temperature below the melt temperature of the fluoropolymer(s) than the same fluoropolymer composition further comprising crosslinks of a chemical curing agent. In some embodiments, the fluoropolymer composition has an irreversible second cycle storage modulus increase (relative to the first cycle storage modulus) at a temperature in a range from 100° C. to a temperature below the melt temperature of the fluoropolymer(s). The irreversible storage modulus increase is evident by comparing the first cycle storage modulus to the second cycle storage modulus. The second cycle storage modulus can be similar to the same composition further comprising a chemical curing agent.

In some embodiments, the temperature(s) at which the fluoropolymer composition has a higher (e.g. first cycle) tan delta and/or lower (e.g. first cycle) storage modulus and/or irreversible increase in storage modulus (difference between first and second cycle) is 110, 115, 120, 125, 130, 135, 140, 145, 150, 155, 160, 165, 170, 175, 180, 185 190, 195 or 200° C. In other embodiments, the temperature(s) at which the fluoropolymer composition has a higher (e.g. first cycle) tan delta and/or lower (e.g. first cycle) storage modulus and/or irreversible increase in storage modulus is no greater than 350, 345, 340, 335, 330, 325, 320, 315, 310, 305, 300, 295, 290, 285, 280, 275, 270, 265, 260, 255, 250, 254, 240, 235, 230, 225, 220, 215, 210° C. It is appreciated that the higher (e.g. first cycle) tan delta and/or lower (e.g. first cycle) storage modulus and/or higher (e.g. second cycle) storage modulus occurs over a range of temperatures, such range being formed from the specific temperatures just described. For example, in some embodiments, the fluoropolymer composition has a (e.g. first cycle) higher tan delta and/or lower first cycle storage modulus than the same fluoropolymer composition further comprising crosslinks of a chemical curing agent is at a temperature range from at least 100, 110, or 120° C. to no greater than 155, 165, or 175° C.

In some embodiments. the fluoropolymer composition has a first cycle storage modulus of less than 0.30 MPa (e.g. at 150° C.). In some embodiments, the first cycle storage modulus at a higher temperature (e.g. 190° C.) is greater than the first cycle storage modulus at a lower temperature (e.g. 150° C.). The first cycle storage modulus at a higher temperature (e.g. 190° C.) can be at least 0.1 MPa, 0.2 MPa or 0.3 MPa as compared to the first cycle storage modulus at a lower temperature (e.g. 150° C.). In some embodiments, the storage modulus at a higher temperature (e.g. at 190° C.) can be at least 1.25×, 1.5×, 1.75×, 2×, or 2.25× the storage modulus at a lower temperature (e.g. 150° C.). This characteristic allows the fluoropolymer composition to be thermally processed at lower temperatures.

In some embodiments, the (e.g. second cycle) tan delta at a lower temperature (e.g. 150° C.) ranges from 0.1 to 0.3 MPa. In some embodiments, the (e.g. second cycle) tan delta at a lower temperature (e.g. 150° C.) is at least 0.15 or 0.20 MPa. These rheological properties can be determined with a rheology analyzer (TA Instruments ARES G2 rheometer) and measurements were performed in parallel plate mode at a frequency of 1 Hz and a strain of 0.1%. The testing temperature is set to increase from 50° C. to 250° C., then cooled down to 50° C. with 6° C./minute ramping rate.

### Other Optional Additives

The fluoropolymer composition may contain further additives, such as stabilizers, surfactants, ultraviolet (“UV”) absorbers, acid acceptors, antioxidants, plasticizers, lubricants, fillers, and processing aids typically utilized in fluoropolymer processing or compounding, provided they have adequate stability for the intended service conditions. A particular example of additives includes carbon particles, like carbon black, graphite, soot. Further additives include but are not limited to pigments, for example iron oxides, titanium dioxides. Other additives include but are not limited to clay, silicon dioxide, barium sulphate, silica, glass fibers, or other additives known and used in the art.

In some embodiments, the fluoropolymer film and coating compositions comprise am acid acceptors. Acid acceptors can be inorganic or blends of inorganic and organic acid acceptors. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include epoxies, sodium stearate, and magnesium oxalate. Particularly suitable acid acceptors include magnesium oxide and zinc oxide. Blends of acid acceptors may be used as well. The amount of acid acceptor will generally depend on the nature of the acid acceptor used. Typically, the amount of acid acceptor used is between 0.5 and 5 parts per 100 parts of fluorinated polymer.

In some embodiments, the fluoropolymer composition comprises silica, glass fibers, thermally conductive particles, or a combination thereof. Any amount of silica and/or glass fibers and/or thermally conductive partilces may be present. In some embodiments, the amount of silica and/or glass fibers is at least 0.05, 0.1, 0.2, 0.3 wt. % of the total solids of the composition. In some embodiments, the amount of silica and/or glass fibers is no greater than 5, 4, 3, 2, or 1 wt. % of the total solids of the composition. Small concentrations of silica can be utilized to thicken the coating composition. Further, small concentrations of glass fibers can be used to improve the strength of the fluoropolymer film. In other embodiments, the amount of glass fibers can be at least 5, 10, 15, 20, 25, 35, 40, 45 or 50 wt-% of the total solids of the composition. The amount of glass fibers is typically no greater than 55, 50, 45, 40, 35, 25, 20, 15, or 10 wt. %. In some embodiments, the glass fibers have a mean length of at least 100, 150, 200, 250, 300, 350, 400, 450, 500 microns. In other embodiments, the glass fibers have a mean length of at least 1, 2, or 3 mm and typically no greater than 5 or 10 mm. In some embodiments, the glass fibers having length of less than 1.5 mm. In some embodiments, the glass fibers have a mean diameter of at least 1, 2, 3, 4, or 5 microns and typically no greater than 10, 15, 30, or 25 microns. For example quartz fiber having a length of 1 mm and a dimeter of 8 microns is available from Shenjiu, Henan Province, China. The glass fibers can have aspect ratio of at least 3:1, 5:1, 10:1, or 15:1.

In some embodiments, the fluoropolymer composition is free of (e.g. silica) inorganic oxide particles. In other embodiments, the fluoropolymer composition comprises (e.g. silica and/or thermally conductive) inorganic oxide particles. In some embodiments, the amount of (e.g. silica and/or thermally conductive) inorganic oxide particles is at least 5, 10, 15, 20, 25, 30, 35, 40, 45 or 50 wt. % of the total solids of the composition. In some embodiments, the amount of (e.g. silica and/or thermally conductive) inorganic oxide particles is no greater than 90, 85, 80, 75, 70, or 65 wt. % of the total solids of the composition. Various combinations of silica and thermally conductive particles can be utilized. In some embodiments, the total amount of (e.g. silica and thermally conductive) inorganic oxide particles or the amount of a specific type of silica particle (e.g. fused silica, fumed silica, glass bubbles, etc.) or thermally conductive particle (e.g. boron nitride, silicon carbide, aluminum oxide, aluminum trihydrate) is no greater than 60, 55, 50, 45, 40, 35, 30, 25, 20, 15, 10, or 5 wt. % of the total solids of the composition. Higher concentrations of (e.g. silica) inorganic oxide particles can be favorable to further reducing the dielectric properties. Thus, the compositions including (e.g. silica) inorganic oxide particles can have even lower dielectric properties than the fluoropolymer alone.

In some embodiments, the (e.g. silica) inorganic oxide particles and/or glass fibers have a dielectric contant at 1 GHz of no greater than 7, 6.5, 6, 5.5, 5, 4.5, or 4. In some embodiments, the (e.g. silica) inorganic oxide particles and/or glass fibers have a dissipation factor at 1 GHz of no greater than 0.005, 004, 0.003, 0.002, or 0.0015.

In some embodiments, the composition comprises inorganic oxide particles or glass fibers that comprise predominantly silica. In some embodiments, the amount of silica is typically at least 50, 60, 70, 75, 80, 85, or 90 wt. % of the inorganic oxide particles or glass fibers. In some embodiments, the amount of silica is typically at least 90, 91, 92, 93, 94, 95, 96, 97, 98, 99, or greater (e.g. at least 99.5, 99.6, or 99.7) wt-% silica. Higher silica concentrations typically have lower dielectric constants. In some embodiments, (e.g. fused) silica particle can further comprise small concentration of other metals/meta oxides such as Al₂O₃, Fe₂O₅, TiO₂, K₂O, CaO, MgO and Na₂O. In some embodiments, the total amount of such metals/metal oxides (e.g. Al₂O₃, CaO and MgO) is independently no greater than 30, 25, 20, 15, or 10 wt. %. In some emboidments, the inorganic oxide particles or glass fibers may comprise B₂O₃ The amount of B₂O₃ can range up to 25 wt. % of the inorganic oxide particles or glass fibers. In other embodiments, (e.g. fumed) silica particle can further comprise small concentration of additional metals/metal oxides such as Cr, Cu, Li, Mg, Ni, P and Zr. In some embodiments, the total amount of such metals or metal oxides is no greater 5, 4, 3, 2, or 1 wt. %. In some embodiments, the silica may be described as quartz. The amount of non-silica metals or metal oxides can be determined by uses of inductively coupled plasma mass spectrometry. The (e.g. silica) inorganic oxides partilces are typically dissolved in hydrofluroic acid and distilled as H₂SiF₆ at low temperatures.

In some embodiments, the inorganic particles may be characterized as an “agglomerate”, meaning a weak association between primary particles such as particles held together by charge or polarity. Agglomerate are typically physically broken down into smaller entities such as primary particles during preparation of the coating solution. In other embodiments, the inorgnaic partilces may be characterized as an “aggregate”, meaning strongly bonded or fused particles, such as covalently bonded particles or thermally bonded particles prepared by processes such as sintering, electric arc, flame hydrolysis, or plasma. Aggregates are tyically no broken down into smaller entities such as primary particles during preparation of the coating solution. “Primary particle size” refers to the mean diameter of a single (non-aggregate, non-agglomerate) particle.

The (e.g. silica) particles may have various shapes such as spherical, ellipsoid, linear or branched. Fused and fumed silica aggregates are more commonly branched. The aggregate size is commonly at least 10× the primary particle size of discrete part.

In other embodiments, the (e.g. silica) particles may be characterized as glass bubbles. The glass bubble may be prepared from soda lime borosilicate glass. In this embodiment, the glass may contain about 70 percent silica (silicon dioxide), 15 percent soda (sodium oxide), and 9 percent lime (calcium oxide), with much smaller amounts of various other compounds.

In some embodiments, the inorganic oxide particles may be characterized as (e.g. silica) nanoparticles, having a mean or median partilces size less than 1 micron. In some embodiments, the mean or median partilce size of the (e.g. silica) inorganic oxide partilces is at 500 or 750 nm. In other embodiments, the mean partilce size of the (e.g. silica) inorganic oxide particles may be at least 1, 1.5, 2, 2.5, 3, 3.5, 4, 4.5, 5, 5.5, 6, 6.5, 7, 7.5, 8, 8.5, 9, 9.5 or 10 microns. In some embodiments, the mean partilce size in no greater than 30, 25, 20, 15, or 10 microns. In some embodiments, the composition comprises little or no (e.g. colloidal silica) nanopartilces having a particle of 100 nanometers or less. The concentration of (e.g. colloidal silica) nanopartilces is typically less than (10, 9, 8, 7, 6, 5, 4, 3, 2, or 1 wt. %) The inorganic oxide (e.g. silica particle) may comprise a normal distribution of particle sizes having a single peak or a distribution of particles having two or more peaks.

In some embodiments, no greater than 1 wt. % of the (e.g. silica) inorganic oxide partilces have a partilce size greater than or equal to 3 or 4 microns. In some embodiments, no greater than 1 wt. % of the (e.g. silica) inorganic oxide partilces have a partilce size greater than or equal to 5 or 10 microns. In other embodiments, no greater than 5, 4, 3, 2, or 1 wt. % of the partilces have a partilce size greater than 45 microns. In some embodiments, no greater than 1 wt. % of the partilces have a partilce size ranging from 75 to 150 microns.

In some embodiments, the mean or median particle size refers to the “primary particle size” referring to the mean or median diameter of discrete a non-aggregated, non-agglomerated particles. For example, the particle size of colloidal silica or glass bubbles is typically the mean or median partilce size of In preferred embodiments, the mean or median particle size refers to the mean or median diameter of the aggregates. The particle size of the inorganic particles can be measured using transmission electron microscopy. The particle size of the fluoropolymer coating solution can be measured using dynamic light scattering.

In some emboidments, the (e.g. silica) inorganic partilces have a specific gravity ranging from 2.18 to 2.20 g/cc.

Aggregated partilces, such as in the case of fumed and fused (e.g. silica) particles, can have a lower surface area than primary particles of the same size. In some embodiments, the (e.g. silica) partilce have a BET surface area ranging from about 50 to 500 m²/g. In some embodiments, the BET surface area is less than 450, 400, 350, 300, 250, 200, 150, or 100 m²/g. In some embodiments, the inorganic nanoparticles may be characterized as colloidal silica. It is appreciated that unmodified colloidal silica nanoparticles commonly comprise hydroxyl or silanol functional groups on the nanoparticle surface and are typically characterized as hydrophilic.

In some emboidments, (e.g. silica aggregate) inorganic particles and especially colloidal silica nanopartilces are surface treated with a hydrophobic surface treatment. Common hydrophobic surface treatments include compounds such as alkoxylsilanes (e.g. octadecytriethoxysilane), silazane, or siloxanes. Various hydrophobic fumed silicas are commercially available from AEROSIL™, Evonik, and various other suppliers. Representative hydrophobic fumed silica include AEROSIL™ grades R 972, R 805, RX 300, and NX 90 S.

In some embodiments, (e.g. silica aggregate) inorganic particles are surface treated with a fluorinated alkoxysilane silane compound. Such compounds typically comprise a perfluoroalkyl or perfluoropolyether group. The perfluoroalkyl or perfluoropolyether group typically has no greater than 4, 5, 6, 7, 8 carbon atoms. The alkoxysilane group can be bonded to the alkoxy silane group with various divalent linking groups including alkylene, urethane, and —SO₂N(Me)-. Some representative fluorinated alkoxy silanes are described in U.S. Pat. No. 5,274,159 and WO2011/043973; incorporated herein by reference. Other fluorinated alkoxy silanes are commercially available.

In some embodiments, the thermally conductive inorganic particles are preferably an electrically non-conductive material. Suitable electrically non-conductive, thermally conductive materials include ceramics such as metal oxides, hydroxides, oxyhydroxides, silicates, borides, carbides, and nitrides. Suitable ceramic fillers include, e.g., silicon oxide, zinc oxide, alumina trihydrate (ATH) (also known as hydrated alumina, aluminum oxide, and aluminum trihydroxide), aluminum nitride, boron nitride, silicon carbide, and beryllium oxide. Other thermally conducting fillers include carbon-based materials such as graphite and metals such as aluminum and copper. Combinations of different thermally conductive materials may be utilized. Such materials are not electrically conductive, i.e. have an electronic band gap greater than 0 eV and in some embodiments, at least 1, 2, 3, 4, or 5 eV. In some embodiments, such materials have an electronic band gap no greater than 15 or 20 eV. In this embodiment, the composition may optionally further comprise a small concentration of thermally conductive particles having an electronic band gap of less than 0 eV or greater than 20 eV.

In favored embodiments, the thermally conductive particles comprise a material having a bulk thermal conductivity>10 W/m*K. The thermal conductivity of some representative inorganic materials is set forth in the following table.

Thermally Conductive Materials

| | Thermal | Electronic | | |
|---|---|---|---|---|
| | Conductivity | Band Gap | | |
| Material | (W/m*K) | (eV) | Density | |
| α-Aluminum Oxide¹ | 30 | 5-9 | 3.95 | g/cc |
| Alumina Trihydrate² | 21 | | 2.42-2.45 | g/cc |
| Silicon Carbide (SiC)¹ | 120 | 2.4 | 3.21 | g/cc |
| Hexagonal Boron Nitride | 185-300 | 2.1 | 2.1 | g/cc |
| (BN)¹ | | | | |

In some embodiments, the thermally conductive particles comprise material(s) having a bulk thermal conductivity of at least 15 or 20 W/m*K. In other embodiments, the thermally conductive particles comprise material(s) having a bulk thermal conductivity of at least 25 or 30 W/m*K. In yet other embodiments, the thermally conductive particles comprise material(s) having a bulk thermal conductivity of at least 50, 75 or 100 W/m*K. In yet other embodiments, the thermally conductive particles comprise material(s) having a bulk thermal conductivity of at least 150 W/m*K. In typical embodiments, the thermally conductive particles comprise material(s) having a bulk thermal conductivity of no greater than about 350 or 300 W/m*K.

Thermally conductive particles are available in numerous shapes, e.g. spheres and acicular shapes that may be irregular or plate-like. In some embodiments, the thermally conductive particles are crystals, typically have a geometric shape. For example, boron nitride hexagonal crystals are commercially available from Momentive. Further, alumina trihydrate is described as a hexagonal platelet. Combinations of particles with different shapes may be utilized. The thermally conductive particles generally have an aspect ratio less than 100:1, 75:1, or 50:1. In some embodiment, the thermally conductive particles have an aspect ratio less than 3:1, 2.5:1, 2:1, or 1.5:1. In some embodiments, generally symmetrical (e.g., spherical, semi-spherical) particles may be employed.

Boron nitride particles are commercially available from 3M as “3M™ Boron Nitride Cooling Fillers”.

In some embodiments, the boron nitride particles has a bulk density of at least 0.05, 0.01, 0.15, 0.03 g/cm³ ranging up to about 0.60, 0.70, or 0.80 g/cm³. The surface area of the boron nitride particle can be <25, <20, <10, <5, or <3 m²/g. The surface area is typically at least 1 or 2 m²/g.

In some embodiments, the particle size, d(0.1), of the boron nitride (e.g. platelet) particles ranges from about 0.5 to 5 microns. In some embodiments, the particle size, d(0.9), of the boron nitride (e.g. platelet) particles is at least 5 ranging up to 20, 25, 30, 35, 40, 45, or 50 microns.

### Methods of Providing and Bonding Fluoropolymer Film

The method of bonding a substrate comprises providing a fluoropolymer film comprising a first fluoropolymer and optionally, but preferably, a second fluoropolymer. At least one fluoropolymer and typically the first (e.g. amorphous) fluoropolymer comprises halogen cure sites. The fluoropolumer film comprises one or more compounds comprising an electron donor group and one or more ethylenically unsaturated groups. The method further comprises applying the fluoropolymer film to a substrate; and heating the fluoropolymer film to a temperature at least 150, 160, 170, 180, 190, or 200° C.

In some embodiments, a fluoropolymer film is obtained by providing a coating solution comprising i) the first fluoropolymer, ii) optional second fluoropolymer and iii) one or more compounds comprising an electron donor group and one or more ethylenically unsaturated groups; and iv) a fluorinated solvent; applying the coating solution to the substrate or release liner; and removing the solvent. The coating solution may optionally comprise additives.

In some embodiments, the dried coagulated latex of the first (e.g. amorphous) fluoropolymer or dried co-coagulated latex mixture of the first amorphous and second crystalline fluoropolymers is combined with a fluorinated solvent. In other embodiments, the second crystalline fluoropolymer is not co-coagulated. Dried powders of the first (e.g. amorphous) fluoropolymer and second crystalline fluoropolymer can separately be added to the fluorinated solvent.

The fluoropolymer(s) are typically first mixed with the fluorinated solvent and one or more compounds comprising an electron donor group and one or more ethylenically unsaturated groups; to form a homogeneous solution prior to adding any optional additives. The one or more compounds comprising an electron donor group and one or more ethylenically unsaturated groups may be pre-dispersed in a non-fluorinated organic solvent, such as alcohol (e.g. methanol). In some embodiments, the pre-dispersion comprises at least 10, 15, 20, or 25 wt. % non-fluorinated solvent ranging up to about 50 wt. % solvent. The dispersion(s) or one or more compounds comprising an electron donor group and one or more ethylenically unsaturated groups are then added to the fluorinated solvent.

The fluoropolymer coating solution comprises at least one fluorinated solvent. The solvent is capable of dissolving the first (e.g. amorphous) fluoropolymer. The solvent is typically present in an amount of at least 25% by weight based on the total weight of the coating solution composition. In some embodiments, the solvent is present in an amount of at least 30, 35, 40, 45, 50, 55, 60, 65, 70, 75, 80, 85, 90, 95% or greater based on the total weight of the coating solution composition.

The fluoropolymer (coating solution) composition typically comprises at least 0.01, 0.02, 0.03, 0.03, 0.04, 0.04, 0.05, 0.06, 0.7, 0.8, 0.9 or 1% by weight of fluoropolymer, based on the weight of the total coating solution composition (including the fluorinated solvent). In some embodiments, the fluoropolymer coating solution composition comprises at least 2, 3, 4, or 5% by weight of fluoropolymer. In some embodiments, the fluoropolymer coating solution composition comprises at least 6, 7, 8, 9 or 10% by weight of fluoropolymer. The fluoropolymer coating solution composition typically comprises no greater than 50, 45, 40, 35, 30, 25, or 20% by weight of fluoropolymer, based on the weight of the total coating solution composition. It is appreciated that fluoropolymers with lower Mooney values are typically utilized to obtain higher concentrations of fluoropolymer.

The solvent is a liquid at ambient conditions and typically has a boiling point of greater than 50° C. Preferably, the solvent has a boiling point below 200° C. so that it can be easily removed. In some embodiments, the solvent has a boiling point below 190, 180, 170, 160, 150, 140, 130, 120, 110, or 100° C.

The solvent is partially fluorinated or perfluorinated. Thus, the solvent is non-aqueous. Various partially fluorinated or perfluorinated solvents are known including perfluorocarbons (PFCs), hydrochlorofluorocarbons (HCFCs), perfluoropolyethers (PFPEs), and hydrofluorocarbons (HFCs), as well as fluorinated ketones and fluorinated alkyl amines.

In some embodiments, the solvent has a global warming potential (GWP, 100 year ITH) of less than 1000, 900, 800, 700, 600, 500, 400, 300, 200 or 100. The GWP is typically greater than 0 and may be at least 10, 20, 30, 40, 50, 60, 70, or 80.

As used herein, GWP is a relative measure of the global warming potential of a compound based on the structure of the compound. The GWP of a compound, as defined by the Intergovernmental Panel on Climate Change (IPCC) in 1990 and updated in subsequent reports, is calculated as the warming due to the release of 1 kilogram of a compound relative to the warming due to the release of 1 kilogram of CO₂ over a specified integration time horizon (ITH).

$${GWP}_{x} = \frac{{\int }_{0}^{ITH} {F}_{x} {C}_{xo} exp ( - t / {τ}_{x} ) dt}{{\int }_{0}^{ITH} {F}_{{CO}_{2}} {C}_{{CO}_{2}} ( t ) dt}$$

where F is the radiative forcing per unit mass of a compound (the change in the flux of radiation through the atmosphere due to the IR absorbance of that compound), Cₒ is the atmospheric concentration of a compound at initial time, τ is the atmospheric lifetime of a compound, t is time, and x is the compound of interest.

In some embodiments, the solvent comprises a partially fluorinated ether or a partially fluorinated polyether. The partially fluorinated ether or polyether may be linear, cyclic or branched. Preferably, it is branched. Preferably it comprises a non-fluorinated alkyl group and a perfluorinated alkyl group and more preferably, the perfluorinated alkyl group is branched.

In one embodiment, the partially fluorinated ether or polyether solvent corresponds to the formula:

Rf-O—R
wherein Rf is a perfluorinated or partially fluorinated alkyl or (poly)ether group and R is a non-fluorinated or partially fluorinated alkyl group. Typically, Rf may have from 1 to 12 carbon atoms. Rf may be a primary, secondary or tertiary fluorinated or perfluorinated alkyl residue. This means, when Rf is a primary alkyl residue the carbon atom linked to the ether atoms contains two fluorine atoms and is bonded to another carbon atom of the fluorinated or perfluorinated alkyl chain. In such case Rf would correspond to R_{f}¹—CF₂— and the polyether can be described by the general formula: R_{f}¹—CF₂—O—R.

When Rf is a secondary alkyl residue, the carbon atom linked to the ether atom is also linked to one fluorine atoms and to two carbon atoms of partially and/or perfluorinated alkyl chains and Rf corresponds to (R_{f}²R_{f}³)CF—. The polyether would correspond to (R_{f}²R_{f}³)CF—O—R.

When Rf is a tertiary alkyl residue the carbon atom linked to the ether atom is also linked to three carbon atoms of three partially and/or perfluorinated alkyl chains and Rf corresponds to (R_{f}⁴R_{f}⁵R_{f}⁶)—C—. The polyether then corresponds to (R_{f}⁴R_{f}⁵R_{f}⁶)—C—OR. R_{f}¹; R_{f}²; R_{f}³; R_{f}⁴; R_{f}⁵; R_{f}⁶ correspond to the definition of Rf and are a perfluorinated or partially fluorinated alkyl group that may be interrupted once or more than once by an ether oxygen. They may be linear or branched or cyclic. Also a combination of polyethers may be used and also a combination of primary. secondary and/or tertiary alkyl residues may be used.

An example of a solvent comprising a partially fluorinated alkyl group includes C₃F₇OCHFCF₃ (CAS No. 3330-15-2).

An example of a solvent wherein Rf comprises a perfluorinated (poly)ether is C₃F₇OCF(CF₃)CF₂OCHFCF₃ (CAS No. 3330-14-1).

In some embodiments, the partially fluorinated ether solvent corresponds to the formula:

CpF2p+1-O-CqH2q+1
wherein q is an integer from 1 to and 5, for example 1, 2, 3, 4 or 5, and p is an integer from 5 to 11, for example 5, 6, 7, 8, 9, 10 or 11. Preferably, CₚF₂ₚ₊₁ is branched. Preferably, CₚF₂ₚ₊₁ is branched and q is 1, 2 or 3.

Representative solvents include for example 1,1,1,2,2,3,4,5,5,5-decafluoro-3-methoxy-4-(trifluoromethyl)pentane and 3-ethoxy-1,1,1,2,3,4,4,5,5,6,6,6-dodecafluroro-2-(trifluoromethyl)hexane. Such solvents are commercially available, for example, under the trade designation NOVEC from 3M Company, St. Paul, MN.

The fluorinated (e.g. ethers and polyethers) solvents may be used alone or in combination with other solvents, which may be fluorochemical solvents or non-fluorochemical solvents. When a non-fluorochemical solvent is combined with a fluorinated solvent, the concentration non-fluorochemical solvent is typically less than 30, 25, 20, 15, 10 or less than 5 wt. % with respect to the total amount of solvent. Representative non-fluorochemical solvents include alcohols such as methanol, ketones such as acetone, MEK, methyl isobutyl ketone, methyl amyl ketone and NMP; ethers such as tetrahydrofuran, 2-methyl tetrahydrofuran and methyl tetrahydrofurfuryl ether; esters such as methyl acetate, ethyl acetate and butyl acetate; cyclic esters such as delta-valerolactone and gamma-valerolactone.

The coating composition described herein including fluorinated solvent is “stable, meaning that the coating composition remains homogeneous when stored for at least 24 hours at room temperature in a sealed container. In some embodiments, the coating composition is stable for one week or more. “Homogeneous” refers to a coating composition that does not exhibit a visibly separate precipitate or visibly separate layer when freshly shaken, placed in a 100 ml glass container and allowed to stand at room temperature for at least 4 hours.

The fluoropolymer compositions provided herein are suitable for coating substrates and may be adjusted (by the solvent content) to a viscosity to allow application by different coating methods, including, but not limited to spray coating or printing (for example but not limited to ink-printing, 3D-printing, screen printing), painting, impregnating, roller coating, bar coating, dip coating, solvent casting and paste coating.

In some embodiments, the fluoropolymer coating solutions are liquids having a viscosity of less than 2,000 mPas at room temperature (20° C.+/−2° C.). In other embodiments, the fluoropolymer coating solution compositions are pastes. The pastes may have, for example, a viscosity of from 2,000 to 100,000 mPas at room temperature (20° C.+/−2° C.).

The coating solution can be applied to the substrate or release liner as a single layer or multiple layers. When applied as a single layer, the coating solution comprises the fluoropolymer(s) together with the bonding agents and optional components. When the coating solution is applied as multiple layers, the layers collectively comprise such components. However, each layer does not necessarily comprise all the components. For example a thin layer of the bonding components with little or no fluoropolymer may be applied to the substrate followed by a second layer comprising fluoropolymer(s) and additives. Thus, the fluoropolymer film comprises multiple layers wherein the mulitple layers collectively comprises the fluoropolymer(s), bonding agents and optional components

After applying the coating solution to the substrate or a release layer, the method further comprises removing the fluorinated solvent, e.g. by evaporation in a closed system wherein the fluorinated solvent is recycled. Illustrative laboratory drying conditions are described in the forthcoming examples. It is appreciated that faster drying times can be achieved with drying equipment having greater thermal energy and circulation capacity. In adequate drying can result in higher dielectric properties.

When the coating solution is applied to the substrate, a fluoropolymer film is formed as a result of removal of the fluorinated solvent. When the coating solution is applied to a release liner and dried, the method further comprising applying the fluoropolymer film of the release liner to the substrate.

In some embodiment, the method further comprises heating the fluoropolymer film to a temperature at or above the melting temperature of the second crystalline fluoropolymer. Notably the melting temperature of the second crystalline fluoropolymer, as previously described is greater than the bonding temperature. The fluoropolymer film may be heated prior to or after applying the fluoropolymer film to the substrate. For example, in the forthcoming example the fluoropolymer film was “pre-baked” at 288° C. for 15-20 minutes.

In some embodiments, the method optionally comprises rubbing (e.g. buffing, polishing) the dried coating/fluoropolymer as described in previously cited WO2021/091864. Rubbing can reduce film defects and reduce haze in the resulting fluoropolymer film.

Average roughness (Ra) of the surface is the arithmetic average of the absolute values of the surface height deviation measured from the mean plane. The fluoropolymer film (e.g. obtained from coagulated latex) can have a low average roughness. In some embodiments, Ra is at least 40 or 50 nm, ranging up to 100 nm before rubbing. In some embodiments, the surface after rubbing is at least 10, 20, 30, 40, 50 or 60% smoother. In some embodiments, Ra is less than 35, 30, 25, or 20 nm after rubbing.

When a thin coating is prepared from micron sized fluoropolymer particles the average roughness can be greater. In some embodiments, the average roughness is micron sized. However, when the thickness of the fluoropolymer film is greater than the particle size of the (e.g. crystalline) fluoropolymer particles, the surface of the fluoropolymer film can have a low average roughness, as previously described.

In other embodiments, the fluoropolymer(s) and one or more compounds comprising an electron donor group and one or more ethylenically unsaturated groups can be combined in conventional rubber processing equipment to provide a solid mixture, i.e. a solid polymer containing the additional ingredients, also referred to in the art as a “compound”. Typical equipment includes rubber mills, internal mixers, such as Banbury mixers, and mixing extruders. During mixing the components and additives are distributed uniformly throughout the resulting fluorinated polymer “compound” or polymer sheets. This solid mixture may be dissolved in fluorinated solvent to form a coating solution or this solids mixtures may be applied to the substrate by thermally extrusion onto the substrate.

In some embodiments, the dried coating or fluoropolymer film has a thickness of 0.1 microns to 10 mils. In some embodiments, the thickness is at least 0.2, 0.3, 0.4, 0.5, or 0.6 microns. In some embodiments, the thickness is at least 1, 2, 3, 4, 5, 6, 7, 8, 9, or 10 microns ranging up to 100, 150, or 200 microns. In some embodiments, the thickness is at least 20, 25, 30, or 35 microns. In some embodiments, the thickness is no greater than 50, 45, or 40 microns. Single or multiple layers may be utilized to achieve the desried thickness.

The method of bonding a fluoropolymer film comprises heating or in other words thermally bonding the fluoropolymer in the absence of (e.g. UV or e-beam) actinic irradiation. The heating is carried out at an effective temperature and effective time to create optimal bonding and other (e.g. dielectric) physical properties. Heating may be carried out under pressure or without pressure in an oven. The bonding temperature is typically at least 150° C. as previously described. The bonding temperature is typically no greater than 380, 370, 360, or 350° C. In some embodiments, the bonding temperature is no greater than 340, 330, 320, 310, 300, 290 or 280° C. In some embodiments, the bonding temperature is above the melting temperature of the second fluoropolymer. In other emboidments, the bonding temperature is below the melting temperature of the second fluropolymer. When the bonding temperature is below the melting temperature of the second fluoropolymer, the method may further comprise heating the fluorpolymer film to a temperature above the melting temperature of the second fluoropolymer before or after bonding the fluoropolymer to the substrate.

In some embodiments, heat and optional pressure are applied for 60 minutes. In some embodiments, method comprising heat the bonded substrate 15-20 minutes at 288° C. It is appreciated that thicker films may require longer heating times and thinner films shorter times. Heating times can also be reduced by using heat sources with greater thermal energy.

The substrate may be organic, inorganic, or a combination thereof. Suitable substrates may include any solid surface and may include substrate selected from glass, plastics (e.g. polycarbonate), composites, metals (copper, stainless steel, aluminum, carbon steel), metal alloys, wood, paper among others. The coating may be colored in case the compositions contains pigments, for example titanium dioxides or black fillers like graphite or soot, or it may be colorless in case pigments or black fillers are absent. The method is especially suitable when the substrate is opaque such that the substrate has little or no transmission of ultraviolet radiation.

Primers may optionally be used to pretreat the surface of the substrate before coating. For example, bonding of the coating to metal surfaces may be improved by applying a bonding agent or primer. Examples include commercial primers or bonding agents, for example those commercially available under the trade designation CHEMLOK. However, the improved adhesion can be obtained in the absence of primers.

The fluoropolymer films (e.g. dried coating compositions) can exhibit good adhesion to various substrates, especially copper. In some embodiment, the (e.g. copper) substrate has an average peak to valley height surface roughness (i.e. Rz) of about 1 to 1.5 microns. In other embodiments, the substrate has an Rz of greater than 1.5, 2, 2.5, or 3 microns. In some embodiment, the substrate has an Rz) of no greater than 5, 4, 3, 2 or 1.5 microns. For example, in some embodiments, the T-peel to copper foil is at least 5, 6, 7, 8, 9 or 10 N/cm ranging up to 15, 20, 25 30, or 35 N/cm or greater as determined by the test method described in the examples. The T-peel to copper foil can be determined at various temperature including room temperature (e.g. 25° C.) and temperatures greater than room temperature. In some embodiments, the T-peel test temperature is at least 50, 75, 100, or 120° C. or greater.

In addition to telecommunication articles, the fluoropolymer coating composition and film can be used for other articles including impregnated textiles, for example protective clothing. Another example of an impregnated textile is a glass scrim impregnated with the (e.g. silica containing) fluoropolymer composition described herein. Textiles may include woven or non-woven fabrics. Other articles include articles exposed to corrosive environments. for example seals and components of seals and valves used in chemical processing, for example but not limited to components or linings of chemical reactors, molds, chemical processing equipment for example for etching, or valves, pumps and tubings, in particular for corrosive substances or hydrocarbon fuels or solvents; combustion engines, electrodes, fuel transportation, containers for acids and bases and transportation systems for acids and bases, electrical cells, fuel cells, electrolysis cells and articles used in or for etching.

As used herein the term “partially fluorinated alkyl” means an alkyl group of which some but not all hydrogens bonded to the carbon chain have been replaced by fluorine. For example, an F₂HC—, or an FH₂C— group is a partially fluorinated methyl group. Alkyl groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, residues of the formula F₂ClC— or FHClC— are also partially fluorinated alkyl residues.

A “partially fluorinated ether” is an ether containing at least one partially fluorinated group, or an ether that contains one or more perfluorinated groups and at least one non-fluorinated or at least one partially fluorinated group. For example, F₂HC—O—CH₃, F₃C—O—CH₃, F₂HC—O—CFH₂, and F₂HC—O—CF₃ are examples of partially fluorinated ethers. Ethers groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, ethers of the formula F₂ClC—O—CF₃ or FHClC—O—CF₃ are also partially fluorinated ethers.

The term “perfluorinated alkyl” or “perfluoro alkyl” is used herein to describe an alkyl group where all hydrogen atoms bonded to the alkyl chain have been replaced by fluorine atoms. For example, F₃C— represents a perfluoromethyl group.

A “perfluorinated ether” is an ether of which all hydrogen atoms have been replaced by fluorine atoms. An example of a perfluorinated ether is F₃C—O—CF₃.

The following examples are provided to further illustrate the present disclosure without any intention to limit the disclosure to the specific examples and embodiments provided.

### EXAMPLES

Unless otherwise noted or readily apparent from the context, all parts, percentages, ratios, etc. in the Examples and the rest of the specification are by weight.

| Abbreviation | Description | Source |
|---|---|---|
| PFE 1 (no halogen | Coagulated gum obtained from 36.4 wt. % solids aqueous 45erfluoroelastomers | |
| cure sites) | latex-51.3 wt. % TFE, 48.7 wt. % PMVE, having a Mooney value of 77. | |
| PFE 2 | Coagulated gum obtained from 30 wt. % solids aqueous 45erfluoroelastomers | |
| | latex-50.4 wt. % PMVE, 49.6 wt. % TFE, and 0.4 wt. % iodine, having a | |
| | Mooney value of 40. | |
| PFE 3 | Coagulated gum obtained from 34 wt. % solids aqueous 45erfluoroelastomers | |
| | latex-49 wt. % PMVE, 51 wt. % TFE, 0.36 wt. % bromine, having a Mooney | |
| | value of 60. | |
| PFE 4 | Coagulated gum obtained from 34 wt. % solids aqueous 45erfluoroelastomers | |
| | latex-49 wt. % PMVE, 51 wt. % TFE, 0.4 wt. % bromine, having a Mooney | |
| | value of 90. | |
| PFE 5 | Coagulated gum obtained from 33.0 wt. % solids aqueous 46erfluoroelastomers | |
| | latex-52.1 wt. % TFE, 47.2 wt. % PMVE, 0.37 wt. % bromine, having a Mooney | |
| | value of 84. | |
| PFE 6 | Coagulated gum obtained from 30.9 wt. % solids aqueous 46erfluoroelastomers | |
| | latex-53.5 wt. % TFE, 45.7 wt. % PMVE, 0.37 wt. % bromine, having a Mooney | |
| | value of 40. | |
| PFE 7 | Coagulated gum obtained from 32.5 wt. % solids aqueous 46erfluoroelastomers | |
| | latex-52.4 wt. % TFE, 46.8 wt. % PMVE, 0.36 wt. % bromine, having a Mooney | |
| | value of 76. | |
| PFE 8 | Coagulated gum obtained from 33.8 wt. % solids aqueous 46erfluoroelastomers | |
| | latex-49.9 wt. % TFE, 49.6 wt. % PMVE, 0.27 wt. % bromine, having a Mooney | |
| | value of 51. | |
| PFA 1 | Latex (28.0 wt. % solids) comprising a polymer of TFE (97.4 wt. %), PMVE | |
| | (CF2═CF—O—CF3, 1.7 wt. %) and CF2═CF—CF2—O—C3F7 (0.9 wt. %), | |
| | melting point 306° C., MFI (372° C./5 kg) 2.2 g/10 min, particle size 134 nm | |
| PFA 2 | Latex (28.0 wt. % solids) comprising a polymer of TFE (96.8 wt. %), PMVE | |
| | (CF2═CF—O—CF3, 1.9 wt. %) and CF2═CF—CF2—O—C3F7 (1.3 wt. %), | |
| | melting point 305° C., MFI (372° C./5 kg) 1.6 g/10 min, particle size 79 nm | |
| PFA 3 | Latex (17.5 wt. % solids) comprising a polymer of TFE (97.8 wt. %), PMVE | |
| | (CF2═CF—O—CF3, 2.17 wt. %), melting point 317° C., particle size 170 nm. | |
| PFA 4 | Fluoroplastic powder, a copolymer of CF2═CF2 & CF₂═CFOCF₂CF₂CF₃ | |
| | (5 wt. %), median particle size 8-10 micrometers | |
| 3 M ™ Dyneon ™ | Low molecular weight PTFE, average particle size 8 microns, 325 C. melting | |
| PTFE TF 9205 | peak temperature, melt flow rate 12 g/10 min | |
| 3 M ™ Dyneon ™ | PTFE agglomerate having an average particle size of about 4 μm | |
| PTFE TF 9202Z | | |
| FluoX-1406 PTFE | micronized polytetrafluoroethylene containing clusters of sub- | AGC |
| micron particles | micron particles | |
| 3 M ™ Dyneon ™ | Fluorinated ethylene propylene-melt flow index-22 g/10 min, | 3 M Dyneon |
| Fluoroplastic | melting point-252° C., average particle size-5 microns | |
| Powder | | |
| FEP 6322PZ | | |
| Novec 7300/ | 3-methoxy perfluorinated 4-methyl pentane | 3 M EMSD |
| (HFE-7300) | | |

Electron Donor Compounds

| | | |
|---|---|---|
| | 1,3-bis(dimethylamino)-2-propanol | Aldrich |
| | 1,6-diaminohexane | Alfa Aesar |
| DBU | 1,8-diazabicyclo[5.4.0]undec-7-ene | Aldrich |
| | 2-(4-pyridylethyl)triethoxysilane | Aldrich |
| 2-DMAP | 2-dimethylaminopyridine | Aldrich |
| APTMS | 3-aminopropyltrimethoxy silane | Gelest |
| | | Corporation |
| APTES | 3-aminopropyltriethoxysilane | |
| | 4,4-trimethylene bis(1-methylpiperidene) | Aldrich |
| APTPDMS | Aminopropyl terminated polydimethyl siloxane | Gelest |
| | | Corporation |
| | Aniline | Aldrich |
| BTMSPA | Bis-[3-(trimethoxysilyl)-propyl]-amine | Gelest |
| | | Corporation |
| DMPP | Dimethylphenylphosphine | Aldrich |
| HFPO(NSi)2 | As described in PCT/IB2022/053074 | 3 M |
| | N-[3-(trimethoxysily1)propyl]ethylenediamine | Aldrich |
| | N,N-dimethyl-3-amino propyltrimethoxysilane | Gelest |
| | | Corporation |
| PhAMTES | N-Phenylaminomethyltriethoxysilane | Gelest |
| | | Corporation |
| PhAPTMS | N-Phenylaminopropyltrimethoxy silane | Gelest |
| | | Corporation |
| | N-phenylpiperazine | Aldrich |
| PhTMS | Phenyltrimethoxysilane | Gelest |
| | | Corporation |
| | Tetraethylene pentamine | Aldrich |
| | Tri-n-butyl ester phosphite | Aldrich |
| | Tri-n-butylphosphine | Aldrich |
| GB | Glass bubbles, density = 0.515 g/cm³, crush strength = 11,000 psi, | |
| | D50 = 7.6 microns, D95 = 16.6 microns | |
| | Glass composition described by US9006302 col 14, line 63-col 15, | |
| | line 2 | |
| BF6 | 4,4-Hexafluoropropylbisphenol | 3 AdMD |
| PFE(03C) | 20 wt % of a salt of 4-methyl-α,α- | 3 M AdMD. |
| | bis(trifluoromethypbenzylmethanol and tetrabutyl phosphonium | |
| | (1:1) (described in US 7,402,630) on AEROSIL (trade name) | |
| | R972 (Hydrophobic fumed silica. Nippon Aerosil Co., Ltd.) | |
| PFE(07C) | A salt of 4-methyl-α,α-bis(trifluoromethypbenzylmethanol and | 3 M AdMD |
| | tetrabutyl phosphonium (1:1) (described in US 7,402,630). | |
| | Anisole | Aldrich |
| | N,N-dimethylaniline | Aldrich |
| | Xylene | Aldrich |

Ethylenically unsaturated compounds

| | | |
|---|---|---|
| Ally1-TMS | Allyltrimethoxysilane | Aldrich |
| TAIC | Triallyl Isocyanurate | TCI |
| | | Chemicals |
| vSSQ | vinylsilsesquioxane | Aldrich |
| XBD | xylene bis(diallyl isocyanurate) | Kasei Co., |
| | | Ltd |
| TA-G | 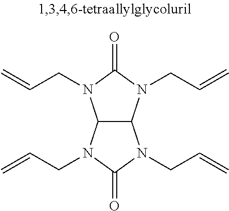 [SMILES: C=CCN1C(=O)N(CC=C)C2C1N(CC=C)C(=O)N2CC=C] | SHIKOKU Chemicals |

Additives

| | | |
|---|---|---|
| QZ | Quartz fiber having a length less than 1.5 mm | |
| CQ0282 | Surface modified Fused silica (D90 = 3 microns; Average = | Suzhou Ginet |
| | 1-2 microns) | |
| CQ0382 | Unmodified Fused silica (D90 = 3 microns; Average = | Suzhou Ginet |
| | 1-2 microns) | |
| PTFE sheets | PTFE Fiberglass Fabric Sheet Roll PTFE-Coated Fabrics Sheet | Amazon |
| | Roll Sublimation Heat Resistant PTFE Rolls for Heat Press | |
| | Transfer, 5 Mil Thickness (PTFE content 58%, Manufactured by | |
| | TOP123, Brand H-E, Part Number 22293) | |

### Test Methods

### Split Post Dielectric Resonator Test Method at 25 GHz

The dried fluoropolymer films were pressed between PTFE sheets at 200° C. for 5-10 minutes prior to Dk and Df measurements.

All split-post dielectric resonator measurements were performed in accordance with the standard IEC 61189-2-721 near a frequency of 25 GHz. Each thin material or film was inserted between two fixed dielectric resonators. The resonance frequency and quality factor of the posts are influenced by the presence of the specimen, and this enables the direct computation of complex permittivity (dielectric constant Dk and dielectric loss Df). The geometry of the split dielectric resonator fixture used in our measurements was designed by the Company QWED in Warsaw Poland. This 25 GHz resonator operates with the TE_{01d} mode which has only an azimuthal electric field component so that the electric field remains continuous on the dielectric interfaces. The split post dielectric resonator measures the permittivity component in the plane of the specimen. Loop coupling (critically coupled) was used in each of these dielectric resonator measurements. This 25 GHz Split Post Resonator measurement system was combined with Keysight VNA (Vector Network Analyzer Model PNA 8364C 10 MHz-50 GHZ). Computations were performed with the commercial analysis Split Post Resonator Software of QWED to provide a powerful measurement tool for the determination of complex electric permittivity of each specimen at 25 GHz.

### T-Peel (Adhesion to Copper) Test Method

The dried perfluoropolymer films were removed from the PET release liner and laminated between 2 pieces of Cu foil (one on the bottom and one on the top) to obtain a sandwich structure with perfluoropolymer composite films in the middle. The copper had a surface roughness Rz of 1.5 microns. Then the laminated sheets were heated at 200° C. under vacuum for 60 minutes between heated platens of a Wabash MPI (Wabash, IN) hydraulic press under 1 Ton pressure and immediately transferred to a cold press. After lamination to copper, some samples were subjected to “Post-bake” heating. This refers to the samples being place in a preheated oven at 288° C. for 6 minutes and then removed from the oven and cooled to room temperature. For each sample, this process was repeated three times. After cooling to room temperature by cold pressing, the resulting sample was subjected to T-peel measurement. The laminated samples were pressed and cut into strips having a 0.5 inch (1.27 cm) width. The T-peel measurement was conducted at various temperatures including room temperature (RT), 120° C. and 150° C. as reported in Tables. The measurement was conducted using an Instron electromechanical universal testing machine (Instron Corp., Norwood, MA) using ASTM D1876 standard method for “Peel Resistance of Adhesives,” more commonly known as the ‘T-peel” test at a peel rate of 6 cm/min for a length of 3 cm. Peel data was generated using an Instron TM model 1125 tester (Instron Corp.) equipped with a Sintech Tester 20 (MTS Systems Corporation, Eden Prairie, MN).

### General Procedure for Perfluoroelastomer (PFE) and PFE/PFA Dispersion

Unless specified otherwise, the PFE and PFA fluoropolymers are available from Dyneon. The fluoropolymers were individually coagulated or co-coagulated with nitric acid except for PFE-4 that was coagulated with magnesium chloride. The coagulated solid was filtered and rinsed with hot (approximately 60° C.) DI water 3-5 times with a period of agitation between each filtration. The solid was decanted and manually squeezed to remove residual water. The solid was then separated back to a granular powder and spread evenly on an aluminum drying tray. The solid was then dried in a forced air oven at 60° C. for 16 hours.

The dried coagulated PFE (alone in case of Table 2) or a 6:4 weight ratio of PFE:PFA were mixed with HFE-7300 separately in 20 wt. % solutions and placed in a roller at a speed of 80 cycles/minute overnight or longer to obtain stable and well-dispersed solutions in HFE-7300. In some examples, other weight ratios of PFE:PFA were used, as specified in such examples. The electron donor compound (e.g. APTMS) was dissolved in methanol to form a 10-20 wt. % solutions prior to addition to the coating solution. The ethylenically unsaturated compounds (e.g. TAIC) was dispersed in methanol at 50 wt. % prior to addition to the coating solution. These bonding agent (BA) solutions were added to the fluoropolymer dispersion in the amounts described in the tables.

Unless specified otherwise, the coating solutions were cast with a notch blade at a 350 um gap on to a PET release liner. In some examples, the coating solution was cast onto the copper foil, as specified in such examples. The coating solutions were allowed to sit on a bench for 5-15 minutes, dried at 60° C. for 15 minutes then at 80° C. for 30 minutes in a forced air oven. The film thickness was 25-40 microns. In some examples, the notch blade had a different gap and/or different drying conditions were used, as specified in such examples. The adhesion to copper at various temperatures and dielectric properties are summarized in the following tables.

TABLE 1
PFE 1/PFA 1 Compositions Lacking Halogen Cure Sites

| Comparative | APTMS or | TAIC | Adhesion to Cu (N/cm) | |
|---|---|---|---|---|
| Examples | BTMSPA wt. % | wt. % | RT | 120° C. |
| 1-1 | 0.00 | 0.00 | 5.10 | 0.10 |
| 1-2 | APTMS (0.15) | 1.00 | | 0.18 |
| 1-3(a) | APTMS (0.50) | 0.50 | | 0.15 |
| 1-4(a) | APTMS (0.50) | 1.00 | 7.30 | 0.16 |
| 1-5(a) | APTMS (1.00) | 1.00 | 7.54 | 0.22 |
| 1-6 | BTMSPA (0.25) | 1.00 | | 0.18 |
| 1-7(b) | PhAPTMS (0.20) | 2.00 | | 0.87 |

(a): coatings dried at 60° C. for 15 minutes then at 100° C. for 30 minutes
(b): coating gap set at 320 um

TABLE 2
Bromo- and iodo-containing perfluoropolymer coating compositions without PFA

| | | | | Adhesion to | Dk and Df | |
|---|---|---|---|---|---|---|
| | PFE | APTMS or | TAIC | Cu (N/cm) | at 25 GHz | |
| Example | gum | PhAPTMS wt. % | wt. % | 120° C. | Dk | Df |

| | | | | | |
|---|---|---|---|---|---|
| Control | PFE 2 | APTMS (0.00) | 0.00 | 0.58 | 0.0021 |
| 2-1(a, d) | | | | | |
| 2-2(a, d) | PFE 2 | APTMS (0.08) | 1.50 | 3.42 | 0.0025 |
| 2-3(b, c) | PFE 2 | PhAPTMS (0.20) | 2.00 | 4.16 | |
| 2-4(b, c) | PFE 6 | PhAPTMS (0.20) | 2.00 | 2.39 | |

(a): dried at 60° C. for 15 minutes then at 100° C. for 10 minutes,
(b): coating solution was coated onto copper foil instead of PET release liner
(c): coating gap = 320 um
(d): Examples were also heat treated at 200° C. for 1 hour between release liner and tested for solubility. At a concentration of 10 wt. %, the fluoropolymer composition was soluble in HFE-7300 solvent.

TABLE 3
PFE 5/PFA 1 and PFE 7/PFA 1

| | | | | Adhesion to Cu (N/cm) | | | Dk and Df | |
|---|---|---|---|---|---|---|---|---|
| | PFE/PFA | APTMS | TAIC | | | 120° C. | at 25 GHz | |
| Example | (6:4) | wt. % | wt. % | RT | 120° C. | Post-Bake | Dk | Df |
| Control | PFE 5/PFA 1 | 0.00 | 0.00 | 5.70 | 0.24 | | 2.01 | 0.00081 |
| 3-1(b) | | | | | | | | |
| Control | PFE 5/PFA 1 | 0.00 | 1.00 | | 0.57 | | 2.05 | 0.00129 |
| 3-2(b) | | | | | | | | |
| 3-3(b) | PFE 5/PFA 1 | 1.00 | 1.00 | 7.77 | 3.28 | | 1.94 | 0.00124 |
| 3-4 | PFE 7/PFA 1 | 0.08 | 1.00 | | 3.53 | | | |
| 3-5(a) | PFE 7/PFA 1 | 0.08 | 2.00 | | | 4.81 | | |
| 3-6 | PFE 7/PFA 1 | 0.15 | 1.00 | 7.00 | 3.23 | | 1.95 | 0.00079 |

(a): coating gap = 560 um.
(B): dried at 60° C. for 30 minutes then at 80° C. for 30 minutes

TABLE 4
PFE 5/PFA 1 and PFE 7/PFA 1

| | | | | Adhesion to | | Dk and Df | |
|---|---|---|---|---|---|---|---|
| | PFE/PFA | BTMSPA | TAIC | Cu (N/cm) | | at 25 GHz | |
| Example | (6:4) | wt. % | wt. % | RT | 120° C. | Dk | Df |
| Control | PFE 5/PFA 1 | 0.00 | 0.00 | 5.70 | 0.24 | 2.01 | 0.00081 |
| 4-1(b) | | | | | | | |
| Control | PFE 5/PFA 1 | 0.00 | 1.00 | 6.21 | 0.57 | 2.05 | 0.00129 |
| 4-2(b) | | | | | | | |
| 4-3 | PFE 7/PFA 1 | 0.15 | 1.00 | | 3.18 | 1.92 | 0.00075 |
| 4-4(b) | PFE 5/PFA 1 | 0.25 | 1.00 | | 3.09 | | |
| 4-5 | PFE 7/PFA 1 | 0.25 | 1.00 | | 3.51 | 2.00 | 0.00075 |
| 4-6(b) | PFE 5/PFA 1 | 1.00 | 1.00 | 7.11 | 3.01 | | |
| Control | PFE 5/PFA 1 | 3.00 | 0.00 | 6.50 | 0.61 | | |
| 4-7(b) | | | | | | | |
| 4-8(b) | PFE 5/PFA 1 | 3.00 | 1.00 | 5.59 | 2.24 | 2.10 | 0.00174 |

(a): coating gap = 500 um
(b): dried at 60° C. for 30 minutes then at 80° C. for 30 minutes

TABLE 5
PFE 7/PFA 1 with various bonding agents (BA)

| | | | | | Adhesion to Cu (N/cm) | | Dk and Df | |
|---|---|---|---|---|---|---|---|---|
| | | BA 1 | | BA 2 | | 120° C. | at 25 GHz | |
| Example | BA 1 | wt. % | BA 2 | wt. % | 120° C. | Post-Bake | Dk | Df |
| 5-1(c, h) | Aniline | 0.10 | APTMS | 0.08 | | 4.45 | | |
| 5-2 I | Aniline | 0.20 | TAIC | 2.0 | 4.7 | 5.89 | 2.04 | 0.00158 |
| 5-3 I | Aniline | 0.20 | XBD^{d} | 2.0 | | 3.73 | | |
| 5-4 (c, i) | Aniline | 0.20 | XBD^{d} | 1.0 | 3.71 | 5.01 | 2.03 | 0.0018 |
| 5-5 | APTMS | 0.08 | Allyl-TMS | 1.0 | 2.53 | | | |
| 5-6 | APTMS | 0.15 | TA-G | 1.0 | 2.63 | | | |
| 5-7 (a) | APTMS | 0.08 | vSSQ | 1.0 | 2.31 | | | |
| 5-8 I | APTPDMS^{d} | 0.20 | TAIC | 2.0 | 5.16 | 5.90 | 2.01 | 0.00184 |
| 5-9 I | APTPDMS^{d} | 0.20 | XBD^{d} | 2.0 | | 4.65 | | |
| 5-10 (c, i) | APTPDMS^{d} | 0.20 | XBD^{d} | 1.0 | 4.25 | 4.94 | 1.98 | 0.0018 |
| 5-11 (a. b) | DBU | 0.25 | TAIC | 2.0 | 2.91 | | | |
| 5-12 | Dimethylphenylphosphine | 0.20 | TAIC | 2.0 | 1.08 | | | |
| 5-13 (a, b) | PhAMTES | 0.20 | TAIC | 2.0 | 3.15 | | | |
| 5-14 (c, h) | PhAPTMS | 0.10 | PhTMS | 0.1 | | 5.24 | | |
| 5-15 (e. g) | PhAPTMS | 0.20 | TA-G | 1.0 | 1.84 | | | |
| 5-16 I | PhAPTMS | 0.20 | TAIC | 2.0 | 4.53 | 5.4 | 1.97 | 0.00131 |
| 5-17 (e. f) | PhAPTMS | 0.20 | vSSQ | 2.0 | 1.25 | | | |
| 5-18 I | PhAPTMS | 0.20 | XBD^{d} | 2.0 | | 4.03 | | |
| 5-19 (c, i) | PhAPTMS | 0.20 | XBD^{d} | 1.0 | 2.22 | 4.97 | 2.02 | 0.00174 |
| 5-20 I | PhTMS | 0.20 | TAIC | 2.0 | 2.15 | 6.50 | 2.05 | 0.00148 |
| 5-21 I | PhTMS | 0.20 | XBD^{d} | 2.0 | | 4.68 | | |
| 5-22 (c, i) | PhTMS | 0.20 | XBD | 1.0 | 2.54 | 5.50 | 2.02 | 0.00174 |
| 5-23 (a, b) | Tri-n-butyl | 0.20 | TAIC | 2.0 | 2.21 | | | |
| | ester phosphite | | | | | | | |
| 5-24 (a, b) | HFPO-N2Si | 0.20 | TAIC | 2.0 | 3.00 | | | |

(a): dried at 60° C. for 30 minutes then at 100° C. for 10 minutes
(b): coating gap of 320 um
(c): coating gap of 560 um
^{d}additive added to coating solution neat (not pre-dispersed in methanol)
(e): coating gap of 200 um
(f): dried at room temperature for 2 hours
(g): dried at room temperature for 68 hours
(h): also included 2 wt. % TAIC
(i): also included 1 wt. % TAIC

TABLE 6
PFE 6/PFA 1 and PFE 3/PFA 1

| | | | | Adhesion to | | Dk and Df | |
|---|---|---|---|---|---|---|---|
| | PFE/PFA | APTMS | TAIC | Cu (N/cm) | | at 25 GHz | |
| Example | (6:4) | wt. % | wt. % | RT | 120° C. | Dk | Df |
| Control | PFE 6/PFA 1 | 0.00 | 0.00 | | 0.23 | 2.01 | 0.00087 |
| 6-1 | | | | | | | |
| Control | PFE 3/PFA 1 | 0.00 | 0.00 | 5.66 | 0.12 | 2.04 | 0.00073 |
| 6-2(a) | | | | | | | |
| 6-3 | PFE 6/PFA 1 | 0.06 | 1.00 | | 3.40 | 1.97 | 0.00085 |
| 6-4 | PFE 6/PFA 1 | 0.08 | 1.00 | 7.47 | 3.24 | 2.02 | 0.00084 |
| 6-5 | PFE 3/PFA 1 | 0.08 | 1.50 | | 3.34 | 2.05 | 0.00079 |
| 6-6 | PFE 3/PFA 1 | 0.08 | 2.00 | | 3.27 | 1.98 | 0.00082 |
| 6-7 | PFE 6/PFA 1 | 0.15 | 0.75 | | 3.00 | 2.07 | 0.00082 |
| 6-8 | PFE 6/PFA 1 | 0.15 | 1.00 | 7.05 | 3.31 | 1.96 | 0.00795 |
| 6-9(a) | PFE 3/PFA 1 | 0.15 | 2.00 | 7.17 | 2.91 | 2.04 | 0.00096 |
| 6-10 | PFE 6/PFA 1 | 0.25 | 1.00 | 6.89 | 3.63 | | |

(a): dried at 60° C. for 15 minutes then at 100° C. for 10 minutes

TABLE 7
PFE 6/PFA 1 and PFE 3/PFA 1

| | | | | Adhesion to | | Dk and Df | |
|---|---|---|---|---|---|---|---|
| | PFE/PFA | BTMSPA | TAIC | Cu (N/cm) | | at 25 GHz | |
| Example | (6:4) | wt. % | wt. % | RT | 120° C. | Dk | Df |
| Control | PFE 6/PFA 1 | 0.00 | 0.00 | | 0.23 | 2.01 | 0.00087 |
| 7-1 | | | | | | | |
| 7-2(a) | PFE 6/PFA 1 | 0.08 | 0.75 | | 1.31 | 1.97 | 0.00079 |
| 7-3(a) | PFE 6/PFA 1 | 0.15 | 0.25 | | 2.41 | 2.02 | 0.00081 |
| 7-4 | PFE 6/PFA 1 | 0.15 | 1.00 | 6.91 | 3.00 | | |
| 7-5 | PFE 6/PFA 1 | 0.25 | 1.00 | 7.24 | 3.24 | | |
| 7-6(b) | PFE 6/PFA 1 | 0.25 | 1.00 | | 4.38 | | |
| 7-7 | PFE 3/PFA 1 | 0.25 | 1.50 | | 3.20 | 2.00 | 0.00076 |
| 7-8 | PFE 6/PFA 1 | 0.50 | 1.00 | 7.27 | 3.52 | | |

(a): coagulated solids pre-dried under vacuum at 50° C. for 24 hours,
(b): coating gap = 500 um,

TABLE 8
Blends of PFE/PFA Coating Solutions with 2 wt. % TAIC

| | PFE 6/PFA 2 | | Bonding | Adhesion to |
|---|---|---|---|---|
| | (6:4):PFE 8/PFA | Bonding | Agent | Cu (N/cm) |
| Example | 2 (6:4) | Agent 1 | (wt. %) | 120° C. |
| Control | 100:0 | N/A | 0.00 | 0.23 |
| No TAIC | | | | |
| 8-1(a) | 100:0 | APTMS | 0.08 | 2.40 |
| 8-2(a) | 5:5 | APTMS | 0.08 | 3.10 |
| 8-3(a) | 3:7 | APTMS | 0.08 | 2.80 |
| 8-4(a) | 5:5 | PhAMTES | 0.20 | 3.48 |
| 8-5(a) | 3:7 | PhAMTES | 0.20 | 3.64 |
| 8-6(a) | 5:5 | PhAPTMS | 0.20 | 3.23 |
| 8-7(a) | 3:7 | PhAPTMS | 0.20 | 3.88 |
| 8-8(b) | 5:5 | APTMS | 0.08 | 4.63 |
| 8-9(b) | 3:7 | APTMS | 0.08 | 3.15 |
| 8-10(b) | 5:5 | PhAMTES | 0.20 | 4.52 |
| 8-11(b) | 3:7 | PhAMTES | 0.20 | 4.22 |
| 8-1 (b) | 5:5 | PhAPTMS | 0.20 | 4.82 |
| 8-13(b) | 3:7 | PhAPTMS | 0.20 | 5.40 |

(a): coating gap = 320 um
(b): coating gap = 570 um

TABLE 9
PFE 6/PFA 1 and PFE 3/PFA 1 with various bonding agents (BA1)

| | | | | | Adhesion to Cu (N/cm) | | | Dk and Df | |
|---|---|---|---|---|---|---|---|---|---|
| | PFE/PFA | | BA 1 | wt. % | | | 120° C. | at 25 GHz | |
| Example | (6:4) | BA 1 | wt. % | TAIC | RT | 120° C. | Post-Bake | Dk | Df |
| 9-1(a) | PFE 3/PFA 1 | 1,3-bis | 0.20 | 2.0 | 7.19 | 1.80 | | | |
| | | (dimethylamino)-2-propanol | | | | | | | |
| 9-2(a) | PFE 3/PFA 1 | 1,6-diaminohexane | 0.20 | 2.0 | 7.33 | 3.05 | | | |
| 9-3(a) | PFE 3/PFA 1 | 2-(4 | 0.20 | 2.0 | 7.35 | 2.88 | | | |
| | | pyridylethyl)triethoxysilane | | | | | | | |
| 9-4(a) | PFE 3/PFA 1 | 2-DMAP | 0.20 | 2.0 | 5.85 | 0.84 | 3.37 | | |
| 9-5(a) | PFE 3/PFA 1 | 4,4- | 0.20 | 2.0 | | 2.90 | | | |
| | | trimethylenebis(1methylpiperidene) | | | | | | | |
| 9-6(a) | PFE 3/PFA 1 | Aniline | 0.20 | 2.0 | 6.18 | 0.72 | 3.89 | 1.99 | 0.00072 |
| 9-7(a, b) | PFE 6/PFA 1 | Anisole | 0.20 | 2.0 | | 1.04 | 4.37 | | |
| 9-8(a) | PFE 3/PFA 1 | APTES | 0.08 | 1.5 | | 3.47 | | | |
| 9-9(d, f) | PFE 3/PFA 1 | APTMS | 0.08 | 1.0 | | 2.06 | | | |
| 9-10(d, g) | PFE 3/PFA 1 | APTMS | 0.08 | 1.0 | | 2.58 | | | |
| 9-11(a) | PFE 3/PFA 1 | APTPDMS | 0.20 | 2.0 | 6.10 | 1.30 | | 2.01 | 0.00105 |
| 9-12(a, e) | PFE 3/PFA 1 | APTPDMS | 0.20 | 2.0 | | 3.07 | | 1.95 | 0.00147 |
| 9-13(b) | PFE 6/PFA 1 | BF6 | 0.20 | 2.0 | | 1.31 | | | |
| 9-14 (a) | PFE 3/PFA 1 | N,N-dimethyl-3- | 0.20 | 2.0 | | 1.17 | | 2.00 | 0.00107 |
| | | aminopropyltrimethoxysilane | | | | | | | |
| 9-15(a, b) | PFE 6/PFA 1 | N,N-dimethylaniline | 0.20 | 2.0 | | 1.25 | 3.52 | | |
| 9-16(a) | PFE 3/PFA 1 | N-[3- | 0.08 | 2.0 | | 1.24 | | | |
| | | (trimethoxysilyl)propyl]ethylenediamine | | | | | | | |
| 9-17(a) | PFE 3/PFA 1 | N-phenylpiperazine | 0.20 | 2.0 | 6.45 | 2.02 | | 2.05 | 0.00091 |
| 9-18(b, c) | PFE 6/PFA 1 | PFE(03C) | 0.20 | 2.0 | | 2.76 | | | |
| 9-19(b) | PFE 6/PFA 1 | PFE(07C) | 0.20 | 2.0 | | 1.49 | | | |
| 9-20(a) | PFE 3/PFA 1 | PhAPTMS | 0.20 | 2.0 | 7.20 | 3.97 | | 1.92 | 0.00076 |
| 9-21 (a) | PFE 3/PFA 1 | PhTMS | 0.20 | 2.0 | | 0.79 | 4.35 | 1.98 | 0.00080 |
| 9-22 (a) | PFE 3/PFA 1 | Tetraethylenepentaamine | 0.20 | 2.0 | 7.58 | 3.17 | | | |
| 9-23 (a) | PFE 3/PFA 1 | Tri-n-butylphosphine | 0.20 | 2.0 | | 3.68 | | 1.98 | 0.00100 |
| 9-24 (b) | PFE 6/PFA 1 | Xylene | 0.20 | 2.0 | | 1.09 | 3.29 | | |

(a): dried at 60° C. for 15 minutes then at 100° C. for 10 minutes
(b): coating gap = 320 um
(c): additive added to coating solution neat (not pre-dispersed in methanol)
(d): dried at 60° C. for 15 minutes then at 120° C. for 20 minutes
(e): additive added to coating solution neat (not pre-dispersed in methanol)
(f): Allyl-TMS instead of TAIC
(g): TA-G instead of TAIC

TABLE 10
PFE 6, 7, and 8 with PFA 1 (6:4 weight ratio)

| | | | | | Adhesion to | Blister after |
|---|---|---|---|---|---|---|
| | | | BA-1 | TAIC | Cu (N/cm) at | Post-bake |
| Example | PFE | Bonding Agent 1 | wt. % | wt. % | 120° C. | Y/N? |
| Control | 6 | N/A | 0.00 | 0.00 | 0.23 | Y |
| 10-1 | | | | | | |
| 10-2 | 6 | APTMS | 0.04 | 1.00 | 1.46 | Y |
| 10-3 | 6 | APTMS | 0.08 | 0.50 | 1.41 | Y |
| 10-4 | 6 | APTMS | 0.08 | 1.00 | 3.95 | N |
| 10-5 | 6 | BTMSPA | 0.25 | 0.50 | 2.25 | Y |
| 10-6 | 6 | BTMSPA | 0.25 | 1.00 | 3.02 | N |
| 10-7 | 7 | Aniline | 0.20 | 2.00 | 4.26 | N |
| 10-8 | 7 | PhAMTES | 0.20 | 2.00 | 3.15 | N |
| 10-9 | 7 | PhTMS | 0.20 | 2.00 | 4.69 | N |
| 10-10 | 7 | APTPDMS | 0.20 | 2.00 | 5.16 | N |
| 10-11 | 7 | PhAPTMS | 0.20 | 2.00 | 4.57 | N |
| Control | 8 | N/A | 0.00 | 0.00 | 0.12 | Y |
| 10-12 | | | | | | |
| 10-13 | 8 | APTMS | 0.08 | 2.00 | 3.27 | N |
| 10-14 | 8 | APTMS | 0.08 | 3.00 | 3.17 | N |
| 10-15 | 8 | APTMS | 0.08 | 5.00 | 2.98 | N |
| 10-16 | 8 | BTMSPA | 0.13 | 1.00 | 2.84 | N |
| 10-17 | 8 | Tri-n-butylphosphine | 0.20 | 2.00 | 3.42 | N |

All coatings were dried at 60° C. for 15 minutes then at 100° C. for 10 minutes in a forced air oven.

### Examples Containing Micron-Sized Fluoropolymer Particles

Micron-sized fluoropolymer particles can be used in combination with or in place of the nano-sized crystalline fluoropolymer in any of the above examples at various weight ratios are previously described. Some examples of such compositions are described as follows:

### General Preparation Procedure for PFE-PFA Micron-Particle Dispersions

The dried PFE coagulated latex was combined with the indicated micron sized fluoropolymer powder and then the mixture was added to HFE-7300 at 20-25 wt, % solids. The mixtures were rolled for 4-5 days to dissolve the PFE and make uniform dispersions. The dispersions were then combined with the described bonding agents (methanol) dispersions as described above, rolled overnight, and then cast onto PET release liner with a notch blade set to a gap of 350 um unless stated otherwise. The coatings were dried at room temperature for approximately 5 minutes and then in a forced air oven at 60° C. for 15 minutes and then at 80° C. for 30 minutes.

TABLE 11
PFE 7/PFA 1 (6:4) blend with 2 wt. % TAIC
and 0.20 wt. % PhAPTMS and additives

| | | Adhesion to Cu (N/cm) | | Dk and Df | |
|---|---|---|---|---|---|
| | Micron Powder | | 120° C. | at 25 GHz | |
| Example | (wt. %) | 120° C. | Post-Bake | Dk | Df |
| 11-1 | N/A | 4.21 | | | |
| 11-2 | CQ0282 (5) | 3.06 | 3.34 | 2.27 | 0.00077 |
| 11-3 | CQ0382 (5) | 2.36 | | | |
| 11-4 | CQ0382 | 1.51 | | | |
| | (5)/GB (5) | | | | |
| 11-5 | CQ0282 (10) | 3.57 | 3.46 | 2.12 | 0.00084 |
| 11-6 | CQ0382 (10) | 2.74 | | | |
| 11-7 | FEP 6322 (10) | 2.46 | | | |
| 11-8 | CQ0282 (20) | 3.54 | 3.47 | 2.12 | 0.00080 |
| 11-9 | CQ0382 (20) | 2.10 | | | |
| 11-10 | FEP 6322 (20) | 1.62 | | | |

All films coated with notch blade set to a gap of 320 um

TABLE 12
PFE 3/PFA 1 (6:4) blend with bonding agents and additives

| | | | | Adhesion to Cu (N/cm) | | Dk and Df | |
|---|---|---|---|---|---|---|---|
| | Micron Powder | APTMS | TAIC | | 120° C. | at 25 GHz | |
| Example | (wt. %) | wt. % | wt. % | RT | Post-Bake | Dk | Df |
| 12-1 | N/A | 0.00 | 0.00 | 5.66 | 0.12 | 2.04 | 0.00073 |
| 12-2(a) | CQ0282 | 0.00 | 0.00 | 5.37 | 0.15 | 2.27 | 0.00072 |
| | (15)/QZ (5) | | | | | | |
| 12-3(a) | CQ0282 (20) | 0.00 | 0.00 | 4.40 | 0.08 | 2.30 | 0.00068 |
| 12-4 | N/A | 0.08 | 2.00 | 6.50 | 2.04 | 2.03 | 0.00088 |
| 12-5(a) | CQ0282 | 0.08 | 2.00 | 6.24 | 1.45 | 2.29 | 0.00082 |
| | (15)/QZ (5) | | | | | | |
| 12-6(a) | CQ0282 (20) | 0.08 | 2.00 | 5.83 | 1.20 | 2.28 | 0.00078 |
| 12-7 | N/A | 0.15 | 2.00 | 7.17 | 2.98 | 2.04 | 0.00096 |
| 12-8(a) | CQ0282 | 0.15 | 2.00 | 5.63 | | 2.30 | 0.00089 |
| | (15)/QZ (5) | | | | | | |
| 12-9(a) | CQ0282 (20) | 0.15 | 2.00 | 5.22 | 0.60 | 2.30 | 0.00085 |

all coatings dried at 60° C. for 15 min then at 100° C. for 10 min
(a): coating solution shear mixed at 2500 rpm for 2 minutes prior to the addition of the additives

TABLE 13
PFE 2 Iodo-containing PFE coating compositions with
2 wt. % TAIC and micron-sized fluoroparticles

| | PFE | | | Adhesion to Cu (N/cm) | | Dk and Df | |
|---|---|---|---|---|---|---|---|
| | 2/Micron powder | | BA 1 | | 120° C. | at 25 GHz | |
| Example | (weight ratio) | BA 1 | wt. % | 120° C. | Post-Bake | Dk | Df |
| 13-1(a) | PFA 4 (6:4) | APTMS | 0.08 | 1.79 | | | |
| 13-2 | PFA 4 (6:4) | Ph-APTMS | 0.20 | 1.29 | 2.31 | 2.03 | 0.0009 |
| Control | FEP 6322PZ | No bonding agents | | 0.16 | 0.10 | 1.94 | 0.00078 |
| 13-3 | (6:4) | | | | | | |
| 13-4 | FEP 6322PZ | Ph-APTMS | 0.20 | 2.67 | 2.14 | 1.96 | 0.00080 |
| | (6:4) | | | | | | |
| 13-5(a) | FEP 6322PZ | APTMS | 0.08 | 1.22 | | | |
| | (6:4) | | | | | | |
| 13-6 | FEP 6322PZ | Ph-APTMS | 0.20 | 2.82 | | 2.03 | 0.00080 |
| | (8:2) | | | | | | |
| 13-7 | PTFE 9205 | Ph-APTMS | 0.20 | 2.60 | | 2.02 | 0.00079 |
| | (8:2) | | | | | | |
| 13-8 | PTFE 9202Z | Ph-APTMS | 0.20 | 1.68 | | 2.03 | 0.00094 |
| | (8:2) | | | | | | |

All films were cast with a notch blade at 320 um gap on a PET release liner.
(A): dried at 60° C. for 15 minutes then at 100° C. for 10 minutes.

TABLE 14
PFE 3 and PFE 6 bromo-containing PFE coating compositions
with micron-sized silica and fluoroparticles

| | | Micron | | | Adhesion to Cu (N/cm) | | | Dk and Df | |
|---|---|---|---|---|---|---|---|---|---|
| | | powder | BA 1 | TAIC | | | 120° C. | at 25 GHz | |
| Example | PFE | (wt. %) | wt. % | wt. % | RT | 120° C. | Post-Bake | Dk | Df |
| Control | 6 | N/A | 0.00 | 0.0 | | 0.53 | | | |
| 14-1(a) | | | | | | | | | |
| Control | 3 | CQ0282 (40) | 0.00 | 0.0 | | 0.12 | | 2.53 | 0.00098 |
| 14-2(b) | | | | | | | | | |
| 14-3(b) | 3 | CQ0282 (40) | Ph-APTMS | 2.0 | | 1.87 | | 2.53 | 0.00078 |
| | | | (0.20) | | | | | | |
| Control | 3 | PFA 4 | 0.00 | 0.0 | | 0.06 | | | |
| 14-4(b) | | (36)/CQ0282 | | | | | | | |
| | | (10) | | | | | | | |
| 14-5(b) | 3 | PFA 4 | Ph-APTMS | 2.0 | | 1.11 | | | |
| | | (36)/CQ0282 | (0.20) | | | | | | |
| | | (10) | | | | | | | |
| 14-6(a) | 3 | FEP 6322PZ | APTMS | 1.5 | 7.50 | 1.71 | | | |
| | | (40) | (0.08) | | | | | | |
| 14-7(b) | 3 | FEP 6322PZ | Ph-APTMS | 2.0 | | 2.11 | 2.56 | 2.05 | 0.00083 |
| | | (40) | (0.20) | | | | | | |
| 14-8(b) | 6 | FEP 6322PZ | APTMS | 1.0 | | 2.08 | | | |
| | | (30) | (0.08) | | | | | | |
| 14-9(b) | 3 | FEP 6322PZ | Ph-APTMS | 2.0 | | 2.36 | 3.01 | 2.00 | 0.00086 |
| | | (30) | (0.20) | | | | | | |
| 14-10(b) | 3 | FEP 6322PZ | Ph-APTMS | 2.0 | | 2.54 | | 2.00 | 0.00089 |
| | | (20) | (0.20) | | | | | | |
| 14-11(a) | 3 | PFA 4 (40) | APTMS | 1.5 | 5.16 | 0.6 | | | |
| | | | (0.08) | | | | | | |
| 14-12(b) | 3 | PFA 4 (40) | Ph-APTMS | 2.0 | | 0.83 | 1.26 | 2.05 | 0.00095 |
| | | | (0.20) | | | | | | |
| 14-13(b) | 3 | PTFE 9202Z | Ph-APTMS | 2.0 | | 1.54 | | | |
| | | (20) | (0.20) | | | | | | |
| 14-14(b) | 3 | PTFE 9205 | Ph-APTMS | 2.0 | | 1.39 | | 2.03 | 0.00081 |
| | | (20) | (0.20) | | | | | | |
| 14-15(b) | 3 | PTFE 9205 | Ph-APTMS | 2.0 | | 1.10 | 1.03 | 2.04 | 0.00073 |
| | | (30) | (0.20) | | | | | | |
| 14-16(a) | 3 | PTFE 9205 | APTMS | 1.5 | 4.85 | 0.62 | | | |
| | | (40) | (0.08) | | | | | | |
| 14-17(b) | 3 | PTFE 9205 | Ph-APTMS | 2.0 | | 0.93 | 0.89 | 1.99 | 0.00076 |
| | | (40) | (0.20) | | | | | | |

(a): dried at 60° C. for 15 minutes then at 100° C. for 10 minutes.
(b): 320 um gap.

TABLE 15
PFE 4 and PFE 7 bromo-containing PFE coating compositions
with micron-sized silica and fluoroparticles

| | | PFA | | | Adhesion to Cu (N/cm) | | | Dk and Df | |
|---|---|---|---|---|---|---|---|---|---|
| | | (PFE/PFA | BA 1 | TAIC | | | 120° C. | at 25 GHz | |
| Example | PFE | Weight Ratio) | (wt. %) | wt. % | RT | 120° C. | Post-Bake | Dk | Df |
| 15-1(b) | 7 | FEP 6322PZ | Ph-APTMS | 2.0 | | 3.22 | | 2.02 | 0.00082 |
| | | (8:2) | (0.20) | | | | | | |
| 15-2(a) | 7 | FEP 6322PZ | APTMS | 1.5 | 8.50 | 2.25 | | | |
| | | (6:4) | (0.08) | | | | | | |
| 15-3(b) | 7 | FEP 6322PZ | Ph-APTMS | 2.0 | | 3.15 | 3.06 | 2.04 | 0.00075 |
| | | (6:4) | (0.20) | | | | | | |
| 15-4(b) | 7 | PFA 4 (6:4) | 0.00 | 0.0 | | | | 2.01 | 0.00091 |
| 15-5(a) | 7 | PFA 4 (6:4) | APTMS | 1.5 | 5.80 | 1.25 | | | |
| | | | (0.08) | | | | | | |
| 15-6(b) | 7 | PFA 4 (6:4) | Ph-APTMS | 2.0 | | 1.54 | 1.49 | 2.03 | 0.00091 |
| | | | (0.20) | | | | | | |
| 15-7(b) | 7 | PTFE 9202Z | Ph-APTMS | 2.0 | | 2.63 | | | |
| | | (8:2) | (0.20) | | | | | | |
| 15-8(b) | 7 | PTFE 9205 | Ph-APTMS | 2.0 | | 2.06 | | 2.04 | 0.00079 |
| | | (8:2) | (0.20) | | | | | | |
| 15-9(b) | 4 | PTFE 9205 | APTMS | 1.0 | | 1.51 | | | |
| | | (7:3) | (0.08) | | | | | | |
| 15-10(a) | 7 | PTFE 9205 | APTMS | 1.5 | 5.64 | 1.25 | | | |
| | | (6:4) | (0.08) | | | | | | |
| 15-11(b) | 7 | PTFE 9205 | Ph-APTMS | 2.0 | | 1.47 | 1.50 | 2.01 | 0.00072 |
| | | (6:4) | (0.20) | | | | | | |

(a): dried at 60° C. for 15 minutes then at 100° C. for 10 minutes.
(b): 320 um gap.

TABLE 16
Peel strength at 150° C. for PFE 6/PFA 1 and
PFE 7/PFA 2 (6:4 weight ratio) blend with bonding agents

| | | | | | Adhesion to Cu (N/cm) | | |
|---|---|---|---|---|---|---|---|
| | | | BA 1 | TAIC | | | 150° C. |
| Example | PFE | PFA | (wt. %) | wt. % | 120° C. | 150° C. | Post-Bake |
| 16-1(a) | 6 | 1 | APTMS | 2.0 | 3.50 | 2.54 | 2.42 |
| | | | (0.1) | | | | |
| 16-2(b) | 7 | 2 | Ph-APTMS | 2.0 | 3.79 | 3.05 | 3.01 |
| | | | (0.2) | | | | |

Coating gap set at 320 um
(a): dried at 60° C. for 15 minutes then at 80° C. for 45 minutes.
(b): dried at 60° C. for 15 minutes then at 80° C. for 25 minutes.

1. A method of bonding a substrate comprising:
providing a fluoropolymer film comprising:
i) a first fluoropolymer comprising at least 80, 85, or 90 wt. % of polymerized perfluorinated monomers;
ii) optionally a second fluoropolymer having a greater amount of polymerized tetrafluoroethylene than the first fluoropolymer;
wherein the first fluoropolymer and/or second fluoropolymer when present comprises halogen cure sites;
iii) one or more compounds comprising an electron donor group and one or more ethylenically unsaturated groups;
applying the fluoropolymer film to a substrate; and
heating the fluoropolymer film to a bonding temperature of at least 150, 160, 170, 180, 190, or 200° C.

2. The method of claim 1 wherein the polymerized perfluorinated monomers of the first fluoropolymer comprise tetrafluoroethene (TFE) and one or more unsaturated perfluorinated alkyl ethers.

3. The method of claim 1 wherein the method lacks exposing the fluoropolymer film to ultraviolet radiation.

4. The method of claim 1 wherein the substrate is opaque such that the substrate has little or no transmission of ultraviolet radiation.

5. The method of claim 4 wherein the substrate is metal or copper.

6. The method of claim 1 wherein after heating to 200° C. for 60 minutes the fluoropolymer layer has a bond strength to copper at 120° C. or 150° C. of at least 1 N/cm.

7. The method of claim 1 wherein the one or more compounds comprising an electron donor group selected from oxido, amine, hydroxy, alkoxy, acrylamide, phosphine, thiol, mercapto, aryl, or combinations thereof.

8. The method of claim 1 wherein the ethylenically unsaturated groups are selected from (meth)acryl, alkenye or alkyne or halide thereof.

9. The method of claim 1 wherein the substrate is a component of a telecommunications article inclusive of printed circuit boards.

10. The method claim 1 wherein the fluoropolymer film is provided by providing a coating solution of i), ii) and iii) and a fluorinated solvent, applying the coating solution to the substrate or release liner, and removing the fluorinated solvent.

11-13. (canceled)

14. The method claim 1 wherein applying the fluoropolymer film by melt extruding the fluoropolymer film.

15. The method of claim 1 wherein the fluoropolymer film comprises the second fluoropolymer.

16. The method of claim 15 wherein the fluoropolymer film comprises particles of a second fluoropolymer.

17-20. (canceled)

21. The method of claim 16 wherein the method further comprises heating the fluoropolymer film to a temperature at or above the melting temperature of the second fluoropolymer when the second fluoropolymer has a melting temperature greater than the bonding temperature.

22. The method of claim 21 wherein heating the fluoropolymer film to a temperature about the melting temperature occurs prior to or after applying the fluoropolymer film to the substrate.

23. The method of claim 1 wherein prior to heating, the first fluoropolymer is soluble in fluorinated solvent inclusive of 3-ethoxy perfluorinated 2-methyl hexane or 3-ethoxy perfluorinated 2-methyl hexane.

24. The method of claim 15 wherein after heating, the first and second fluoropolymers are physically crosslinked.

25. The method of claim 1 wherein the fluoropolymer film further comprises additives inclusive of silica, glass fibers; glass microspheres inclusive or bubbles or beads; or a combination thereof.

26. The method of claim 1 wherein the fluoropolymer film has
i) a dielectric constant (Dk) of less than 2.75, 2.70, 2.65, 2.60, 2.55, 2.50, 2.45, 2.40, 2.35, 2.30, 2.25, 2.20, 2.15, 2.10, 2.05, 2.00, 1.95;
ii) a dielectric loss of less than 0.01, 0.009, 0.008, 0.007, 0.006, 0.005, 0.004, 0.003, 0.002, 0.001, 0.0009, 0.0008, 0.0007, 0.0006;
or a combination thereof.

27. (canceled)

28. An article comprising
a substrate; and
a fluoropolymer layer disposed on the substrate comprising:
i) a first fluoropolymer comprising at least 80, 85, or 90 wt. % of polymerized perfluorinated monomers;
ii) optionally a second fluoropolymer having a greater amount of polymerized tetrafluoroethylene than the first fluoropolymer;
wherein the first fluoropolymer and/or second fluoropolymer when present comprises halogen cure sites;
iii) one or more compounds comprising an electron donor group and one or more ethylenically unsaturated groups;
wherein the fluoropolymer layer has a bond strength to the substrate at a temperature of at least 120° C. of at least 1 N/cm.

29-33. (canceled)
